(19) United States
(12) Patent Application Publication
(10) Pub. No.: US 2024/0000037 A1
(43) Pub. Date: Jan. 4, 2024

(54) Pet litter box and control method of pet litter box

(71) Applicant: Xiaowei (shanghai) Biotechnology Co., Ltd., Shanghai (CN)

(72) Inventors: Zunfeng LIU, Shanghai (CN); Jun XU, Shanghai (CN); Chong WANG, Shanghai (CN)

(73) Assignee: Xiaowei (shanghai) Biotechnology Co., Ltd., Shanghai (CN)

(21) Appl. No.: 18/344,872

(22) Filed: Jun. 30, 2023

(30) Foreign Application Priority Data
Jul. 1, 2022 (CN) 202221694635.2
Mar. 14, 2023 (CN) 202320507919.4
Jun. 5, 2023 (CN) 202310662582.9

(51) Int. Cl. A01K 1/01

(52) U.S. Cl. CPC A01K 1/0114

(57) ABSTRACT

A pet litter box and a control method of a pet litter box are provided. The pet litter box includes: a base and a box body, where the base is provided with a chamber; a top side of the base is provided with a base opening; the box body is provided in the chamber; and the base includes a shell bottom opposite to the base opening and a shell wall provided in a peripheral direction of the shell bottom.

### CROSS REFERENCE TO THE RELATED APPLICATIONS

This application is based upon and claims priority to Chinese Patent Application No. 202221694635.2, filed on Jul. 1, 2022; Chinese Patent Application No. 202320507919.4, filed on Mar. 14, 2023; and Chinese Patent Application No. 202310662582.9, filed on Jun. 5, 2023, the entire contents of which are incorporated herein by reference.

### TECHNICAL FIELD

Embodiments of the present disclosure belong to the field of pet supplies, and in particular relate to a pet litter box and a control method of a pet litter box.

### BACKGROUND

With the continuous improvement of people's material living standards, people's requirements for spiritual life are gradually improving, and more and more people like to keep pets such as cats and dogs. Many people purchase specialized pet houses for their pets. At present, most pet houses are provided with a pet litter box for handling pet excrement.

The existing pet litter boxes solve the excretion problem of pets living with humans, but there are still many shortcomings. For example, in pet litter boxes with fine litter, after the pet excretes, the excrement of the pet is mixed with the fine litter and removed together with the fine litter. These pet litter boxes have a cumbersome operation and cannot achieve reuse of the fine litter. For some pet litter boxes, the box body can be rotated to separate the excrement of the pet from the fine litter to allow reuse of the fine litter. However, in order to prevent the fine litter from falling out of the box body when the box body is rotated, the opening provided for the pet to enter and exit the pet litter box is generally reduced, which restricts the pet from entering and exiting the pet litter box.

An additional shortcoming for the pet litter boxes that achieve the separation of the fine litter from the excrement through the rotation of the existing box body, is that the fine litter cannot fully return to the excretion region of the box body after the excrement is dumped. Besides, after the pet excretes, if the excrement is not removed in a timely manner, there will be a heavy odor in the box body.

### SUMMARY

An objective of embodiments of the present disclosure is to design a pet litter box and a control method of a pet litter box. The present disclosure achieves the separation of fine litter and excrement or waste, and facilitates the entry and exit of the pet into the pet litter box.

To achieve the above objective, an embodiment of the present disclosure provides a pet litter box, including:
a base, provided with a chamber, where a top side of the base is provided with a base opening communicated with the chamber; and
a box body, provided in the chamber, and provided with a box opening, where the box opening is located at a top side of the box body;
the box body includes a box bottom opposite to the box opening and a box wall provided in a peripheral direction of the box bottom; and
the base includes a shell bottom opposite to the base opening and a shell wall provided in a peripheral direction of the shell bottom; and the shell wall encloses the chamber on the shell bottom.

In addition, an embodiment of the present disclosure further provides a control method of a pet litter box. The control method is applied to the pet litter box as described above, and includes the following steps:
driving, according to a received drive instruction, the box body to rotate with the preset axis as a pivot axis, where the box opening is configured to intersect with the base opening of the base when the box body is rotated; and an angle formed by the intersection of the box opening and the base opening changes with the rotation of the box body.

Compared with the prior art, the present disclosure has the base provided with the chamber. The top side of the base is provided with the base opening communicated with the chamber, the box body is located in the chamber of the base, and the box opening of the box body is located at the top side of the box body. In this way, a pet can only enter the box body from a top of the box body, and cannot enter the box body from other portions of the base, effectively preventing the pet from getting stuck. In addition, the box body is rotatable with the preset axis as a pivot axis, the box opening is intersected with the base opening of the base when the box body is rotated, and the angle formed by the intersection of the box opening and the base opening changes with the rotation of the box body. In this way, the box opening and the base opening have large sizes, laying the foundation for the separation of the fine litter and excrement or waste.

### BRIEF DESCRIPTION OF THE DRAWINGS

FIG. 1 is an isometric view of a pet litter box according to some embodiments of the present disclosure;

FIG. 2 is an exploded view of a box body and a base according to some embodiments of the present disclosure;

FIG. 3 is an assembly view of a waste collector and the base according to some embodiments of the present disclosure;

FIG. 4 is a top view of the pet litter box shown in FIG. 1;

FIG. 5A is a section view taken along line G-G shown in FIG. 4;

FIG. 5B is a schematic diagram of the box body at an excrement dumping position according to some embodiments of the present disclosure;

FIG. 5C is a schematic diagram of the box body at a litter return position according to some embodiments of the present disclosure;

FIG. 6A is a schematic diagram of the box body at an initial position when a microswitch serves as a detection module according to some embodiments of the present disclosure;

FIG. 6B is a schematic diagram of the box body at the initial position when a Hall element serves as the detection module according to some embodiments of the present disclosure;

FIG. 7A is a schematic diagram of the box body at the excrement dumping position when a microswitch serves as the detection module according to some embodiments of the present disclosure;

FIG. 7B is a schematic diagram of the box body at the excrement dumping position when a Hall element serves as the detection module according to some embodiments of the present disclosure;

FIG. 8A is a schematic diagram of the box body at the litter return position when a microswitch serves as the detection module according to some embodiments of the present disclosure;

FIG. 8B is a schematic diagram of the box body at the litter return position when a Hall element serves as the detection module according to some embodiments of the present disclosure;

FIG. 9 is an exploded view of the box body and a filter element according to some embodiments of the present disclosure;

FIG. 10 is an exploded view of the box body, the filter element and a rotation support according to some embodiments of the present disclosure;

FIG. 11 is an assembly view of the box body and the rotation support according to some embodiments of the present disclosure;

FIG. 12 is an isometric view of an outer side of a drive device according to some embodiments of the present disclosure;

FIG. 13 is an isometric view of an inner side of the drive device according to some embodiments of the present disclosure;

FIG. 14 is an exploded view of the drive device according to some embodiments of the present disclosure;

FIG. 15 is an isometric view of the drive device integrated inside a shell according to some embodiments of the present disclosure;

FIG. 16 is an isometric view of the filter element according to some embodiments of the present disclosure;

FIG. 17 is a side view of the filter element shown in FIG. 16

FIG. 18 is a bottom view of the rotation support according to some embodiments of the present disclosure;

FIG. 19 is a front view of the rotation support shown in FIG. 18;

FIG. 20 is a section view taken along line A-A shown in FIG. 18;

FIG. 21 is an assembly view of the base and the rotation support according to some embodiments of the present disclosure;

FIG. 22 is a partial enlarged view of B shown in FIG. 21;

FIG. 23 is a schematic diagram of a second clamping protrusion connected to a second support arm according to some embodiments of the present disclosure;

FIG. 24 is an assembly view of the box body and the base according to some embodiments of the present disclosure;

FIG. 25 is a partial enlarged view of C shown in FIG. 24;

FIG. 26 is a partial enlarged view of D shown in FIG. 24;

FIG. 27 is a block diagram of the pet litter box according to some embodiments of the present disclosure;

FIG. 28 is an isometric view of the pet litter box according to some embodiments of the present disclosure;

FIG. 29 is a partial enlarged view of H shown in FIG. 1;

FIG. 30 is an exploded view of a right side of the pet litter box according to some embodiments of the present disclosure;

FIG. 31 is a partial enlarged view of I shown in FIG. 30;

FIG. 32 is an enlarged view of E shown in FIG. 31;

FIG. 33 is an exploded view of a left side of the pet litter box according to some embodiments of the present disclosure;

FIG. 34 is an enlarged view of F shown in FIG. 33;

FIG. 35A is a schematic diagram showing that a litter clean-up plate closes a litter storage region and the box body is at the initial position according to some embodiments of the present disclosure;

FIG. 35B is a schematic diagram showing that the litter clean-up plate closes the litter storage region and the box body is at an excrement dumping position according to some embodiments of the present disclosure,

FIG. 35C is a schematic diagram showing that the litter clean-up plate opens the litter storage region and the box body is at the excrement dumping position according to some embodiments of the present disclosure;

FIG. 35D is a schematic diagram showing that the box body is at the initial position and a filter screen plate is tilted towards the litter storage region according to some embodiments of the present disclosure;

FIG. 36 is an exploded view of the drive device, the rotation support, and a driven shaft according to some embodiments of the present disclosure;

FIG. 37 is an assembly view of the waste collector and a deodorization device according to some embodiments of the present disclosure;

FIG. 38 is an isometric view of the waste collector provided with a liquid storage container according to some embodiments of the present disclosure;

FIG. 39 is an isometric view of a pressing mechanism according to some embodiments of the present disclosure;

FIG. 40 is an exploded view of the pressing mechanism and the liquid storage container according to some embodiments of the present disclosure;

FIG. 41 is a block diagram of the deodorization device of the pet litter box according to some embodiments of the present disclosure;

FIG. 42 is a flowchart of a control method of the pet litter box according to some embodiments of the present disclosure; and

FIG. 43 is a flowchart of another control method of the pet litter box according to some embodiments of the present disclosure.

### DETAILED DESCRIPTION OF THE EMBODIMENTS

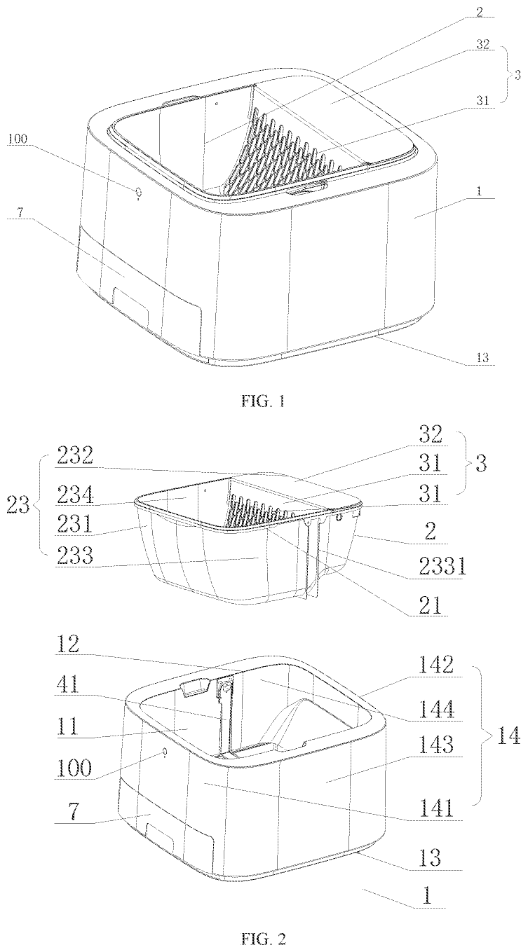

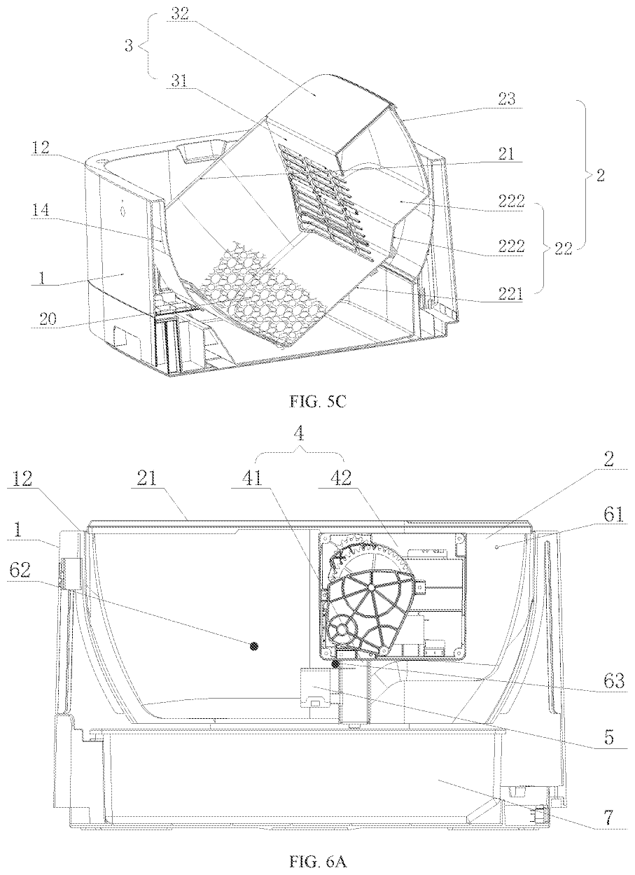

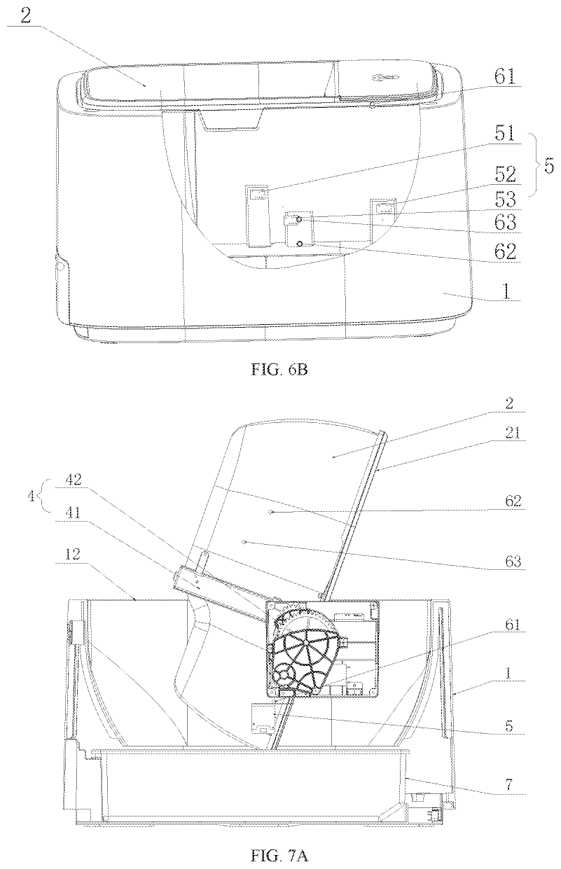

Some embodiments of the present disclosure relate to a pet litter box. As shown in FIGS. 1 and 2, the pet litter box includes base 1 and box body 2. The base 1 is provided with chamber 11. As shown in FIG. 6A, a top side of the base 1 is provided with base opening 12 communicated with the chamber 11.

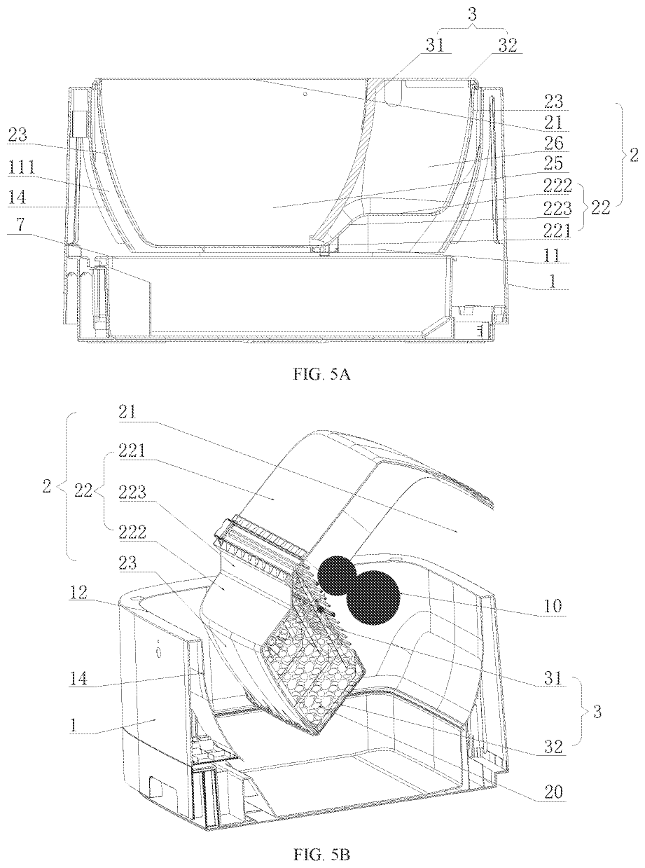

As shown in FIGS. 5A and 6A to 8A, the box body 2 is located in the chamber 11. The box body 2 is provided with box opening 21. The box opening 21 is located at a top side of the box body 2. As shown in FIGS. 1 and 2, the box body 2 includes box bottom 22 opposite to the box opening 21 and box wall 23 provided in a peripheral direction of the box bottom 22.

It is obvious from the above content that the base 1 is provided with the chamber 11, the top side of the base 1 is provided with the base opening 12 communicated with the chamber 11, the box body 2 is located in the chamber 11 of the base 1, and the box opening 21 of the box body 2 is located at the top side of the box body 2. In this way, a pet can only enter the box body 2 from a top of the box body 2, and cannot enter the box body 2 from other portions of the base 1, effectively preventing the pet from getting stuck.

In some embodiments, as shown in FIGS. 1, 2, and 5A, the base 1 includes shell bottom 13 opposite to the base opening 12 and shell wall 14 provided in a peripheral direction of the shell bottom 13. The shell wall 14 encloses the chamber 11 on the shell bottom 13. First avoidance gap 111 is formed between the box wall 23 and the shell wall 14 for a rotation of the box body 2. Through the first avoidance gap 111, the shell wall 14 of the base avoids interference with the rotation of the box body 2 when the box body 2 is rotating.

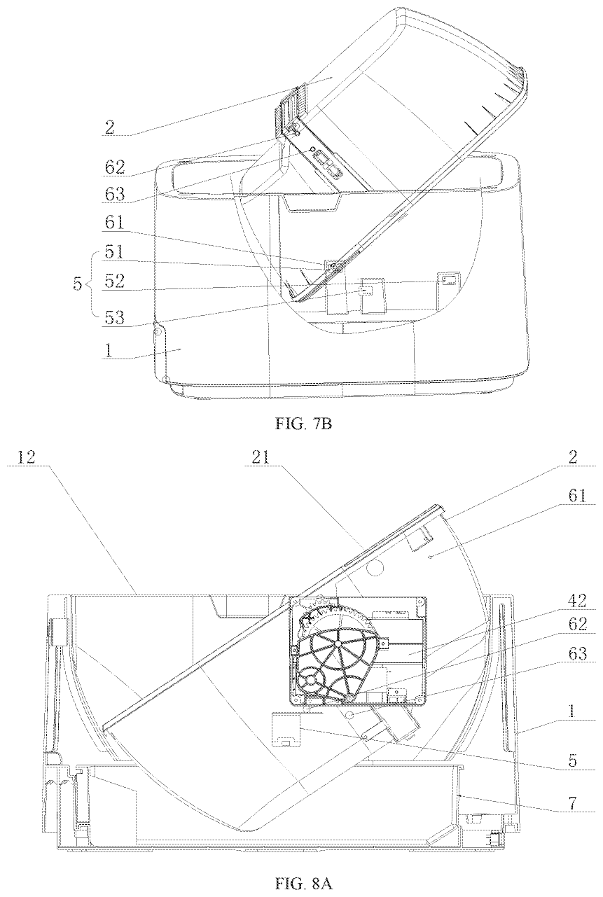

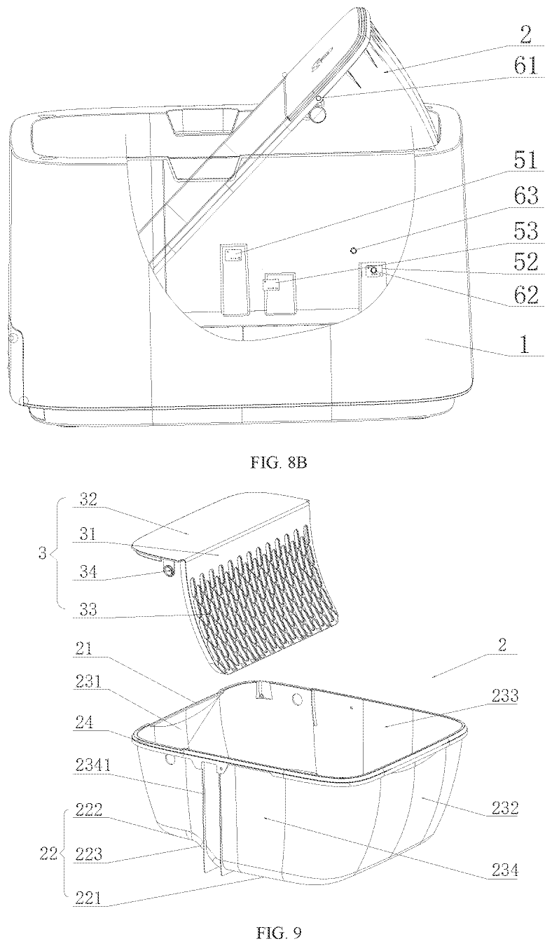

In addition, in some embodiments, as shown in FIGS. 7A to 8A, the box body 2 is rotatable with a preset axis as a pivot axis. The box opening 21 is configured to intersect with the base opening 12 when the box body 2 is rotated, and an angle formed by the intersection of the box opening 21 with the base opening 12 changes with the rotation of the box body 2. In this way, the box opening 21 of the box body 2 and the base opening 12 of the base 1 have large sizes, laying the foundation for the separation of fine litter and excrement or waste.

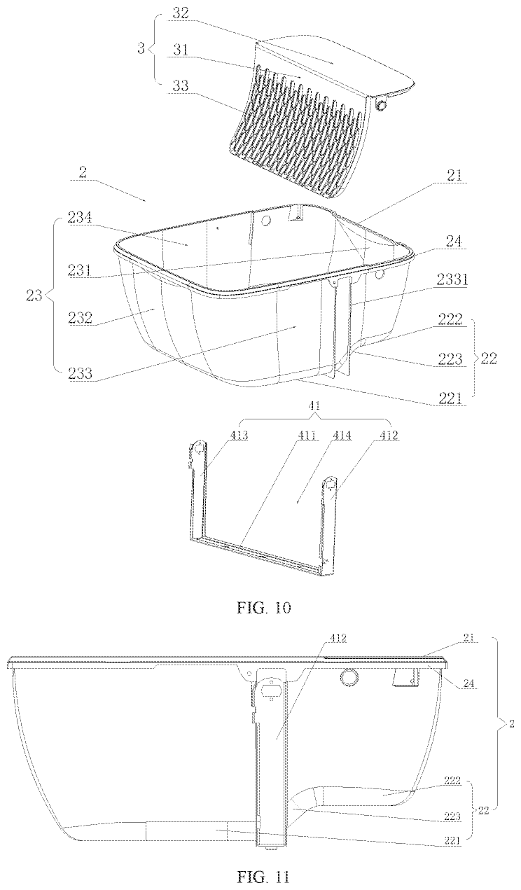

In some embodiments, as shown in FIGS. 6A to 8A, when the box body 2 is rotated, the box opening 21 intersects with the base opening 12 in a direction that is a length direction of the box opening 21. As shown in FIGS. 2 and 9, the box wall 23 includes first side wall 231 and second side wall 232 provided opposite to each other in the length direction of the box opening 21, and third side wall 233 and fourth side wall 234 provided opposite to each other in a width direction of the box opening 21. Similarly, as shown in FIG. 2, when the box body 2 is rotated, the base opening 12 intersects with the box opening 21 in a direction that is a length direction of the base opening 12. The shell wall 14 includes first side plate 141 and second side plate 142 provided opposite to each other in the length direction of the base opening 12, and third side plate 143 and fourth side plate 144 provided opposite to each other in a width direction of the base opening 12. As shown in FIG. 2, the first side wall 231 and the first side plate 141 are provided opposite to each other, while the second side wall 232 and the second side plate 142 are provided opposite to each other. Meanwhile, the third side wall 233 and the third side plate 143 are provided opposite to each other, while the fourth side wall 234 and the fourth side plate 144 are provided opposite to each other. In this way, the first avoidance gap 111 is formed between the first side wall 231 and the first side plate 141, between the second side wall 232 and the second side plate 142, between the third side wall 233 and the third side plate 143, and between the fourth side wall 234 and the fourth side plate 144. As shown in FIGS. 2 and 5A, a side of the first side plate 141 facing the chamber 11 and a side of the second side plate 142 facing the chamber 11 are each provided with a curved surface. Meanwhile, corresponding to the first side plate 141, at least a part of the first side wall 231 from the box opening 21 to the box bottom 22 is bent and extended towards the first side plate 141. Similarly, as shown in FIG. 2, corresponding to the second side plate 142, at least a part of the second side wall 232 from the box opening 21 to the box bottom 22 is bent and extended towards the second side plate 142. In this way, the rotation of the box body 2 is not affected, and a small gap is formed between the shell wall 14 of the base 1 and the box wall 23 of the box body 2, effectively preventing the pet from getting stuck between the box body 2 and the base 1. In some embodiments, as shown in FIG. 9, a part of the box wall 23 from the box opening 21 to the box bottom 22 is bent outward to form brim 24. The brim 24 facilitates a user to rotate the box body 2, avoiding interference of the box body 2 on the rotation of the base 1.

In addition, in some embodiments, as shown in FIGS. 5A and 9, the box body 2 is provided therein with filter element 3. The filter element 3 divides a space inside the box body 2 into excretion region 25 able to contain fine litter and litter storage region 26 communicated with the excretion region 25. The filter element 3 is further provided with filter hole 33 that communicates the excretion region 25 with the litter storage region 26. A size of the filter hole 33 is larger than a size of a fine litter particle and smaller than a size of an excrement particle. For example, a diameter of the filter hole 33 is greater than a diameter of the fine litter particle and smaller than a diameter of the excrement particle. Therefore, the box body 2 is provided with three positions during the rotation, namely an initial position, an excrement dumping position, and a litter return position. As shown in FIGS. 5A and 6A, when the box body 2 is at the initial position, the fine litter is laid flat in the excretion region 25. The excretion region 25 can also accommodate the excrement or waste. When the box body 2 is at the excrement dumping position, as shown in FIGS. 5B and 7A, the box body 2 can be rotated in a forward direction to the excrement dumping position, such that the box opening 21 is tilted towards the base opening 12, and the excretion region 25 of the box body 2 is located above the litter storage region 26. The fine litter can enter the litter storage region 26 through the filter hole 33 of the filter element 3, and the excrement or waste can be rolled down to the base 1 through filter element 3. After the dumping of the excrement or waste is completed, as shown in FIGS. 5C and 8A, the box body 2 can be rotated in a reverse direction to the litter return position. At this position, the box opening 21 of the box body 2 is tilted towards the base opening 12 of the base 1, and the excretion region 25 is located below the litter storage region 26. In this way, the fine litter in the litter storage region 26 can be returned to the excretion region 25 through the filter hole 33 of the filter element 3. After the box body 2 completes the litter return operation, the box body 2 can be rotated in a forward direction to the initial position, such that the box opening 21 of the box body 2 is parallel to the base opening 12 of the base 1.

In some embodiments, as shown in FIG. 9, the filter element 3 includes filter screen plate 31 and litter clean-up plate 32. As shown in FIGS. 4, 5A to 5C, the filter screen plate 31 is extended from the box opening 21 to the box bottom 22. The filter screen plate 31 divided a space in the box body 2 into the excretion region 25 and the litter storage region 26. The litter clean-up plate 32 covers a part of the box opening 21 of the box body 2 to open or close the litter storage region 26. The litter clean-up plate 32 can prevent the pet from entering the litter storage region 26. As shown in FIGS. 5A and 9, through the filter hole 33 of the filter screen plate 31, when the box body 2 is rotated in the forward direction to the excrement dumping position, the fine litter in the excretion region 25 can enter the litter storage region 26. In addition, when the box body 2 is rotated in the reverse direction to the litter return position, the fine litter in the litter storage region 26 can return to the excretion region 25. In some embodiments, the litter clean-up plate 32 may further be connected to the filter screen plate 31. Of course, the litter clean-up plate 32 and the filter screen plate 31 can also be two independent plates. As shown in FIGS. 5A and 9, the entire filter screen plate 31 is curved towards the litter storage region 26. Therefore, the filter screen plate 31 is a curved plate, allowing the excrement on the filter screen plate 31 to accurately fall into the base 1. Of course, in some embodiments, the entire filter screen plate 31 can also be curved towards the excretion region 25. In addition, the filter element 3 is detachably provided on the box body 2. Of course, in other embodiments, the filter element 3 can also be integrally formed with the box body 2.

In addition, in some embodiments, as shown in FIGS. 5A and 9, the box bottom 22 of the box body 2 is provided with first bottom portion 221, second bottom portion 222, and connecting portion 223 connecting the first bottom portion 221 and the second bottom portion 222. A vertical distance from the box opening 21 to the first bottom portion 221 is greater than a vertical distance from the box opening 21 to the second bottom portion 222. The filter screen plate 31 is exactly butted against a side of the connecting portion 223 connected to the first bottom portion 221. The filter screen plate 31 is matched with the connecting portion 223, such that the first bottom portion 221 serves as a bottom of the excretion region 25, and the second bottom portion 222 serves as a bottom of the litter storage region 26. Thus, there is a height difference between the bottom of the excretion region and the bottom of the litter storage region. When the box body 2 is rotated in the forward direction to the excrement dumping position, it does not affect the entry of the fine litter into the litter storage region 26. When the box body 2 is rotated in the reverse direction to the litter return position, the fine litter can quickly return to the excretion region 25. In some embodiments, as shown in FIG. 5A, the connecting portion 223 can further be integrally tilted. That is, from the side connected to the first bottom portion 221 to a side connected to the second bottom portion 222, the entire connecting portion 223 is tilted towards the litter storage region 26. For example, an inclination angle of the connecting portion 223 can be 15-75 degrees, such that a height of a step formed by the connecting portion 223 can account for 10-45% of a height of the box body 2, thereby forming a slope between the first bottom portion 221 and the second bottom portion 222. Therefore, when the box body 2 is rotated in the forward direction to the excrement dumping position, the filter screen plate 31 plays a role in guiding the fine litter into the litter storage region 26. When the box body 2 is rotated in the reverse direction to the litter return position, the filter screen plate accelerates a speed of the fine litter returning to the excretion region 25. In some embodiments, as shown in FIG. 9, the filter element 3 is further provided with connecting element 34 that is elastically hinged to the third side wall 233 and the fourth side wall 234 of the box body 2, allowing the filter element 3 to rotate around the connecting element 34 as a pivot point. Therefore, by rotating the filter element 3, the fine litter in the litter storage region 26 can be manually cleaned. Due to the elastic hinged connection between the filter element 3 and the box body 2, when the box body 2 is rotated, the filter screen plate 31 is firmly butted against the connecting portion 223 to avoid affecting the rotation of the box body 2 at the excrement dumping position and the litter return position.

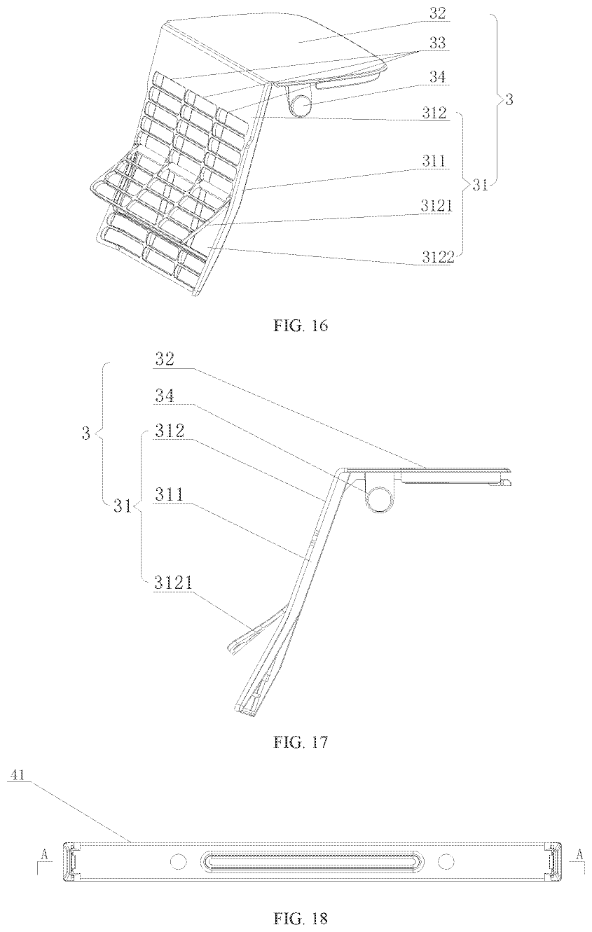

In addition, in some embodiments, as shown in FIGS. 16 and 17, the filter screen plate 31 further includes frame 311 and screen plate body 312. The frame 311 is extended from the box opening 21 to the box bottom 22. The frame 311 is connected to the litter clean-up plate 32 or is an independent component. The screen plate body 312 is located within the frame 311, and a part of the screen plate body 312 forms flip plate 3121 that is flippable towards the excretion region 25. The flip plate 3121 can only be flipped towards the excretion region 25, and cannot be flipped in a reverse direction. A part of the screen plate body 321 forms litter return port 3122 that is opened or closed by the flip plate 3121. Therefore, by flipping the flip plate 3121, the flip plate 3121 can open or close the litter return port 3122. In this way, the user can clean up the litter storage region 26 to return the fine litter in the litter storage region 26 to the excretion region 25, ensuring that the litter storage region 26 is clean.

In addition, as shown in FIGS. 16 and 17, a side of the flip plate 3121 hinged to the frame 311 is parallel to the box opening 21. The flip plate 3121 is configured to flip relative to the frame 311 when the box body 2 is rotated. When the box body 2 is rotated, the flip plate 3121 can be flipped relative to the frame 311 through its own gravity and/or a power produced during a litter return process. For example, when the box body 2 is rotated in the forward direction to the excrement dumping position, as shown in FIG. 7A, the flip plate 3121 can directly close the litter return port 3122 under its own gravity. Thus, the box body 2 can utilize the filter screen plate 31 to dump the excrement or waste, and the fine litter can enter the litter storage region 26 through the filter hole 33 of the filter screen plate 31. When the box body 2 is rotated in the reverse direction to the litter return position, as shown in FIGS. 8A, 16, and 17, the flip plate 3121 can directly open the litter return port 3122 under its own gravity and/or the power produced during the litter return process. The speed of the fine litter entering the excretion region 25 from the litter storage region 26 is accelerated through the litter return port 3122, thereby facilitating the return of the fine litter and achieving rapid laying of the fine litter in the excretion region 25.

Furthermore, it is worth noting that as shown in FIGS. 8A, 16 and 17, when the box body 2 is rotated to the litter return position, a flip angle of the flip plate 3121 relative to the frame 311 is less than 90 degrees. Of course, in some embodiments, when the box body 2 is rotated to the litter return position, the flip angle of the flip plate 3121 relative to the frame 311 can also be greater than 90 degrees. In order to control the flip angle of the flip plate 3211, a corresponding limit structure can be provided at a hinge position between the flip plate 3211 and the frame 311. The flip angle of the flip plate 3211 is controlled through the limit structure to meet a litter return requirement of the box body 2 at different flip angles.

In addition, in some embodiments, as shown in FIGS. 6A, 7A, and 8A, the pet litter box further includes first drive mechanism 4. The first drive mechanism 4 is connected to the box body 2. The first drive mechanism 4 is configured to drive the box body 2 to rotate with a preset axis as a pivot axis. The chamber 11 of the base 1 is further provided therein with detection module 5. Corresponding to the detection module 5, the box body 2 is provided with first element 61, second element 62, and third element 63 that are able to be detected by the detection module 5. As shown in FIG. 27, the first drive mechanism 4 and the detection module 5 are electrically connected to a main control module of the pet litter box. The detection module 5 is a microswitch. The first element 61, the second element 62, and the third element 63 are protrusions located on the box wall 14. Each of the protrusions is provided on the third side wall 233 or the fourth side wall 234, and the microswitch is provided on the third side plate 143 or the fourth side plate 144 of the base 1.

Therefore, when the main control module receives a drive instruction, as shown in FIGS. 27 and 7A, the main control module controls the first drive mechanism 4, enabling the first drive mechanism 4 to drive the box body 2 to rotate in the forward direction. When the microswitch is triggered by the first element 61, the box body 2 is rotated exactly to the excrement dumping position. At this point, the microswitch sends an electrical signal to the main control module. When the main control module receives this electrical signal, it pauses the first drive mechanism 4 to keep the box body 2 at the excrement dumping position, as shown in FIG. 7A. In addition, after the dumping of the excrement or waste in the box body 2 is completed and the fine litter in the excretion region 25 enters the litter storage region 26, as shown in FIG. 8A, the main control module continues to control the first drive mechanism 4, causing the first drive mechanism 4 to drive the box body 2 to rotate in the reverse direction. When the microswitch is triggered by the second element 62, the box body 2 is rotated exactly to the litter return position. At this point, the microswitch sends an electrical signal to the main control module again. When the main control module receives this electrical signal, it pauses the first drive mechanism 4 to keep the box body 2 at the litter return position, as shown in FIG. 8A. Finally, when the fine litter in the litter storage region 26 2 returns to the excretion region 25, the main control module controls the first drive mechanism 4 again, causing the first drive mechanism 4 to drive the box body 2 to rotate in the forward direction again. When the microswitch is triggered by the third element 63, the box body 2 returns to the initial position, as shown in FIG. 6A. At this point, the microswitch sends an electrical signal to the main control module again. When the main control module receives the electrical signal, it turns off the first drive mechanism 4 to keep the box body 2 at the initial position.

It should be noted that the detection module 5 is only explained using the microswitch as an example. In some embodiments, the detection module 5 may also adopt Hall elements. For example, as shown in FIGS. 6B, 7B, and 8B, the detection module 5 includes three Hall elements, namely first Hall element 51, second Hall element 52, and third Hall element 53. Corresponding to these three Hall elements, the first element 61, the second element 62, and the third element 63 are all magnetic elements. Therefore, when the box body 2 is rotated to the excrement dumping position, as shown in FIG. 7B, the first Hall element 51 detects the first element 61, and the first Hall element 51 outputs a first Hall signal to the main control module. After the main control module receives the first Hall signal, it pauses the first drive mechanism 4 to keep the box body 2 at the excrement dumping position. When the box body 2 is rotated to the litter return position, as shown in FIG. 8B, the second Hall element 52 detects the second element 62, and the second Hall element 52 outputs a second Hall signal to the main control module. After the main control module receives the second Hall signal, it pauses the first drive mechanism 4 to keep the box body 2 at the litter return position. Finally, when the box body 2 is rotated to the initial position, as shown in FIG. 6B, the third Hall element 53 detects the second element 63, and the third Hall element 53 outputs a third Hall signal to the main control module. After the main control module receives the third Hall signal, it turns off the first drive mechanism 4 to keep the box body 2 at the initial position.

In addition, in order that the first drive mechanism 4 drives the box body 2 to rotate, as shown in FIGS. 6A, 7A, and 8A, the first drive mechanism 4 includes rotation support 41 and drive device 42. As shown in FIG. 2, the rotation support 41 is provided in the chamber 11 of the base 1 and connected to the box body 2. The drive device 42 is connected to the rotation support 41, and the drive device 42 is configured to drive the rotation support 41 to rotate with a preset axis as a pivot axis. In some embodiments, as shown in FIG. 10, the rotation support 41 includes bottom beam 411, first support beam 412, and second support beam 413. The bottom beam 411 is provided at a bottom of the box body 2. The first support beam 412 is provided at one end of the bottom beam 411 in a length direction of the bottom beam 411, and the second support beam 413 is provided at the other end of the bottom beam 411 in the length direction of the bottom beam 411. The first support beam 412 and the second support beam 413 are extended in a direction perpendicular to the bottom beam 411, such that the first support beam 412, the second support beam 413, and the bottom beam 411 define a clamping region 414 for clamping the box body 2. As shown in FIGS. 2 and 10, an end of the first support beam 412 away from the bottom beam 411 and an end of the second support beam 413 away from the bottom beam 411 are rotatably connected to the base 1. Specifically, the end of the first support beam 412 away from the bottom beam 411 is rotatably connected to the third side plate 143, and the end of the second support beam 413 away from the bottom beam 411 is rotatably connected to the fourth side plate 144. In addition, as shown in FIG. 5A, the drive device 42 is further electrically connected to the main control module. In this way, the drive device 42 can drive the rotation support 41 to rotate with the preset axis as the pivot axis under the control of the main control module, and the box body 2 can be rotated together with the rotation support 41.

In some embodiments, the first support beam 412 and the second support beam 413 are detachably connected to the box body 2. For example, as shown in FIGS. 9, 10, and 11, the box body 2 is provided with first slide way 2331 for inserting the first support beam 412 and second slide way 2341 for inserting the second support beam 413. The first support beam 412 and the second support beam 413 are slid into the first slide way 2331 and the second slide way 2341, respectively, to achieve the connection between the rotation support 41 and the box body 2.

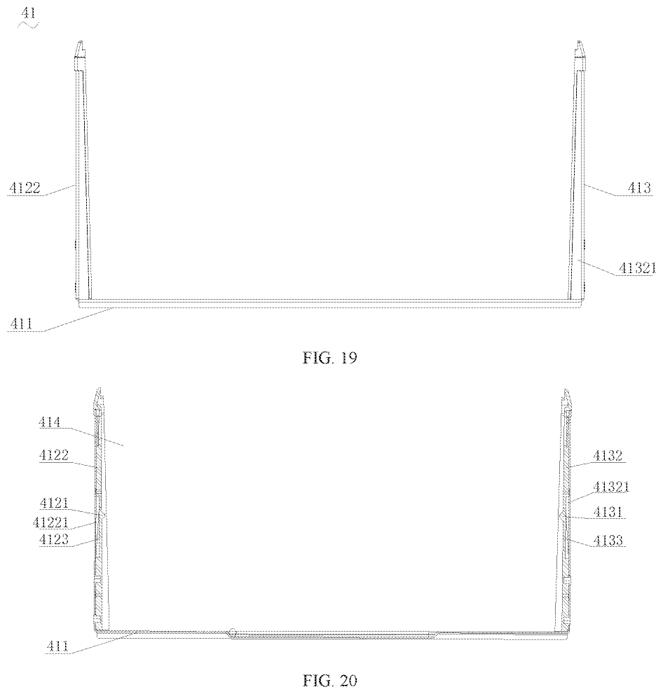

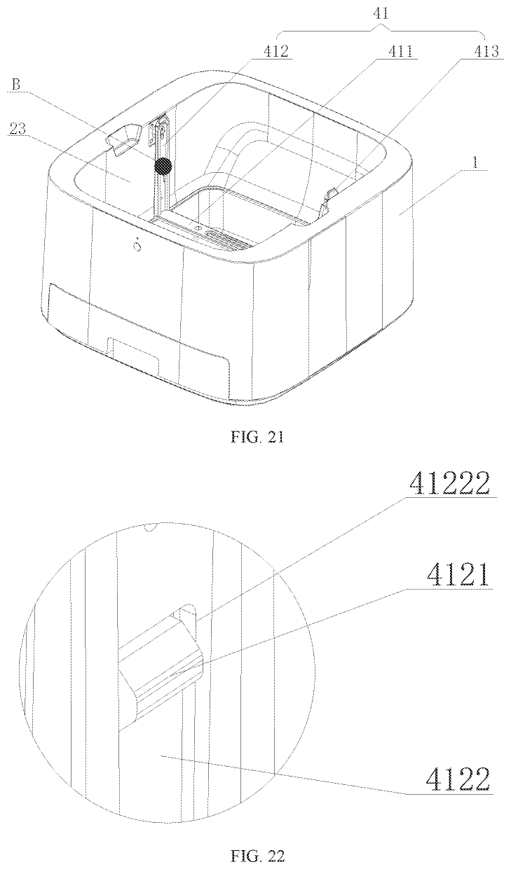

Further, in some embodiments, as shown in FIGS. 18 to 20, one side of the first support beam 412 opposite to the second support beam 413 is provided with first clamping protrusion 4121, and one side of the second support beam 413 opposite to the first support beam 412 is provided with second clamping protrusion 4131. As shown in FIGS. 21, 25, and 26, the box wall 23 of the box body 2 is provided with first limit protrusion 2311 that is clamped by the first clamping protrusion 4121 and second limit protrusion 2321 that is clamped by the second clamping protrusion 4131. By clamping the first limit protrusion 2311 by the first clamping protrusion 4121 and the second limit protrusion 2321 by the second clamping protrusion 4131, the mounting of the box body 2 in the chamber 11 is achieved.

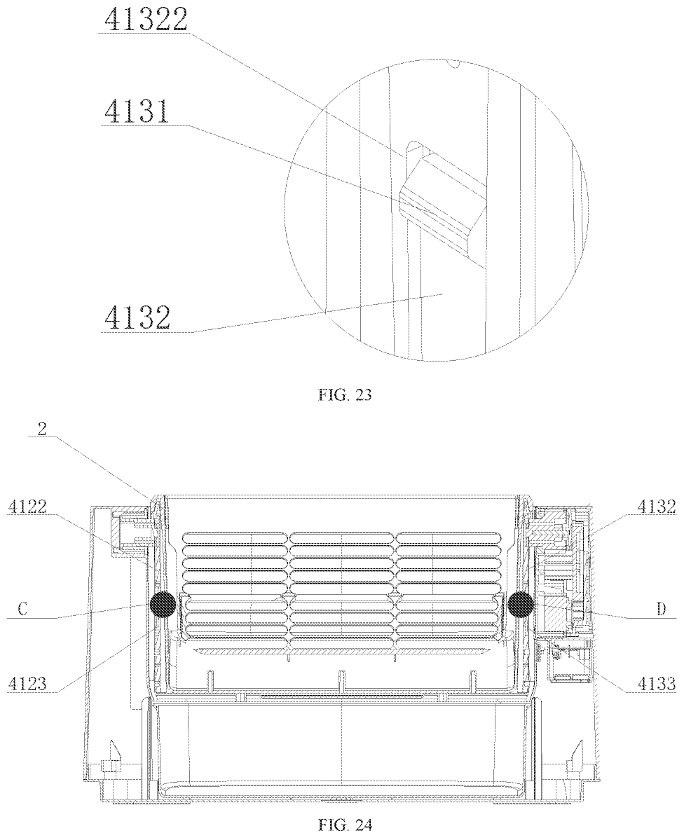

In some embodiments, as shown in FIGS. 20 and 24, the first support beam 412 includes first support arm 4122 and first elastic arm 4123. The first support arm 4122 is connected to the bottom beam 411 and is extended vertically away from the bottom beam 411. The first support arm 4122 is provided with first rebound space 41221. As shown in FIG. 22, a side of the first support arm 4122 opposite to the second support beam 413 is provided with first clamping hole 41222 communicated with the first rebound space 41221. The first elastic arm 4123 is located in the first rebound space 41221. As shown in FIGS. 21 and 22, a part of the first elastic arm 4123 forms the first clamping protrusion 4121. The first clamping protrusion 4121 protrudes from the first clamping hole 41222 and is exposed at the side of the first support arm 4122 opposite to the second support beam 413. The first elastic arm 4123 is reboundable relative to the second support beam 4122. Correspondingly, as shown in FIGS. 20 and 24, the second support beam 413 includes second support arm 4132 and second elastic arm 4133. The second support arm 4132 is connected to the bottom beam 411 and is extended vertically away from the bottom beam 411. The second support arm 4132 is provided with second rebound space 41321. As shown in FIG. 23, a side of the second support arm 4132 opposite to the first support beam 412 is provided with second clamping hole 41322 communicated with the second rebound space 41321. The second elastic arm 4133 is located in the second rebound space 41321. As shown in FIGS. 21 and 23, a part of the second elastic arm 4133 forms the second clamping protrusion 4131. The second clamping protrusion 4131 protrudes from the second clamping hole 41322 and is exposed at the side of the second support arm 4132 opposite to the first support beam 412. The second elastic arm 4133 is reboundable relative to the second support beam 4132.

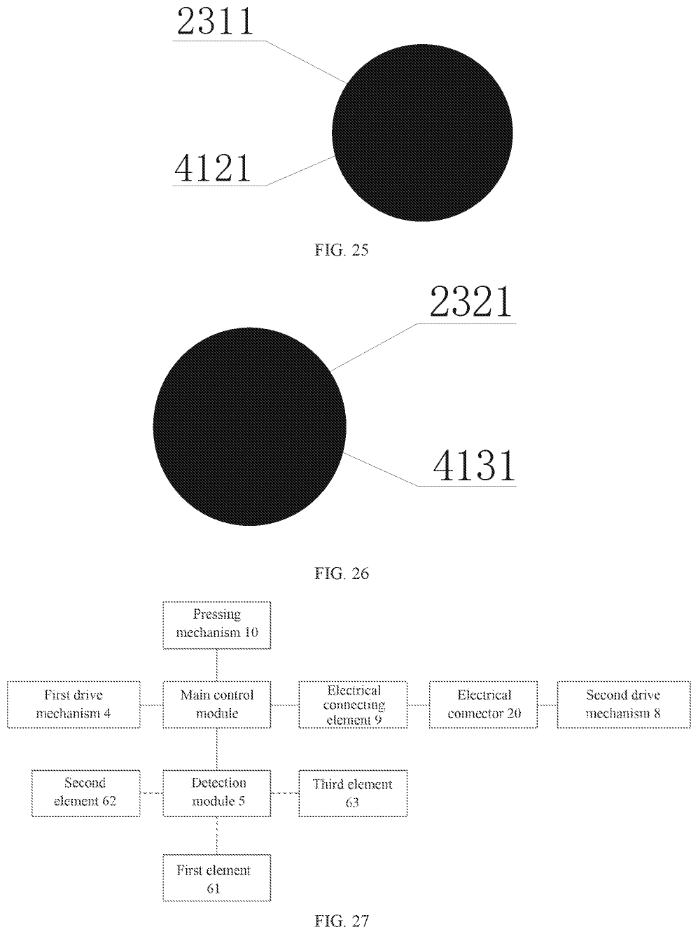

Therefore, when the box body 2 is put into the chamber 11, as shown in FIGS. 10 and 24, the first support beam 412 and the second support beam 413 are slid into the first slide way 2331 and the second slide way 2341 of the box body 2, respectively. During this process, the first clamping protrusion 4121 on the first support beam 412 and the second clamping protrusion 4131 on the second support beam 413 are respectively squeezed by the first limit protrusion 2311 and the second limit protrusion 2321 on the box body 2. In this way, the first elastic arm 4123 and the second elastic arm 4133 can respectively be deflected for an avoidance purpose through the first rebound space 41221 and the second rebound space 41321. When the first clamping protrusion 4121 and the second clamping protrusion 4131 respectively cross the first limit protrusion 2311 and the second limit protrusion 2321, as shown in FIGS. 25 and 26, the first elastic arm 4123 and the second elastic arm 4133 can rebound with their own rebound performance. In this way, the first clamping protrusion 4121 and the second clamping protrusion 4131 are respectively clamped with the first limit protrusion 2311 and the second limit protrusion 2321, thereby completing the mounting of the box body 2 in the chamber 11.

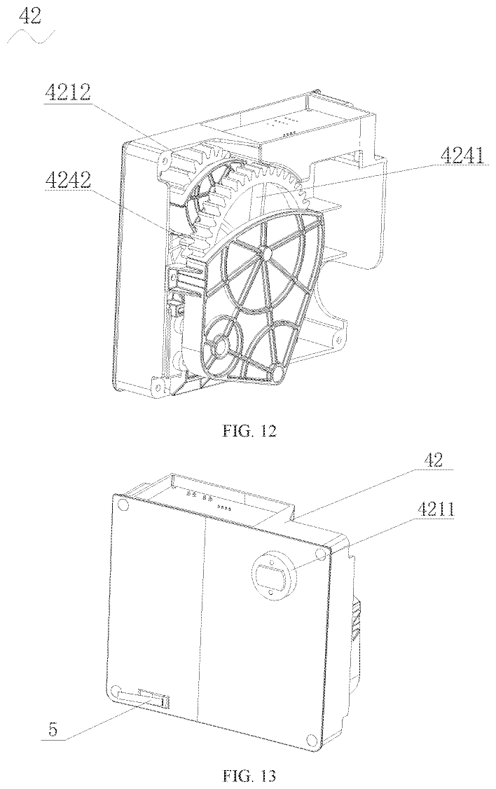

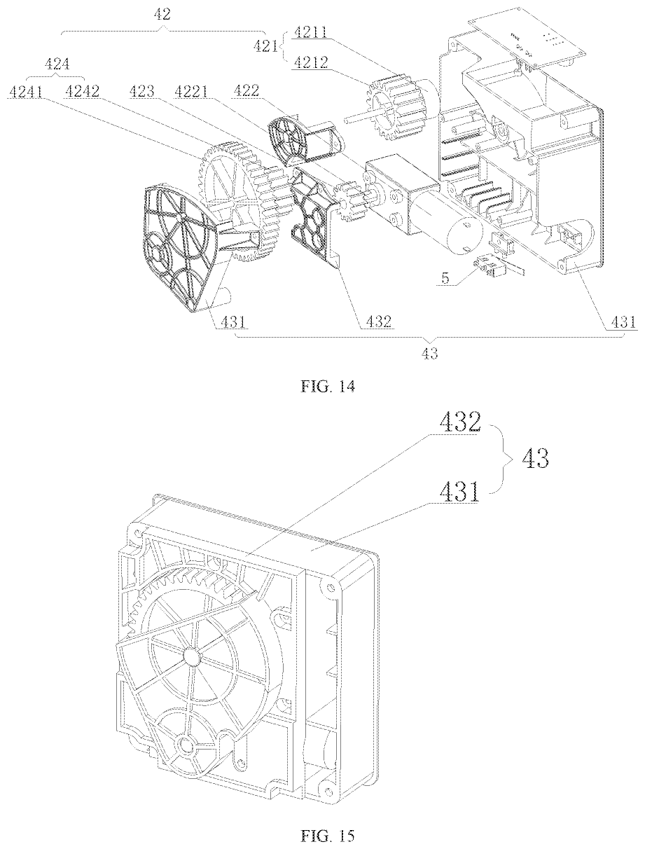

In addition, as shown in FIGS. 12, 13, and 14, the drive device 42 includes transmission element 421, motor drive element 422, a driving gear 423, and a gear set 424. As shown in FIG. 14, the transmission element 421 is provided with connecting portion 4211 connected to the first support beam 412 or the second support beam 413, and drive gear 4212 coaxially connected to the connecting portion 4211. The motor drive element 422 is provided with spindle 4221, and the driving gear 423 is coaxially connected to the spindle 4221 of the motor drive element 422. The gear set 424 is engaged with the driving gear 423 and the drive gear 4212. The gear set 424 includes first driven gear 4241 and second driven gear 4242 coaxially connected to the first driven gear 4241. The first driven gear 4241 is engaged with the driving gear 423, and the second driven gear 4242 is engaged with the drive gear 4212. In addition, the motor drive element 422 is electrically connected to the main control module, such that the main control module controls the spindle 4221 of the motor drive element 422 to rotate in a forward or reverse direction based on a received drive instruction.

As shown in FIGS. 14 and 15, the first drive mechanism 4 further includes shell 43. The shell 43 is configured to accommodate the drive device 42, such that the first drive mechanism is mounted and fixed on the base 1 through the shell 43. Meanwhile, as shown in FIGS. 14 and 15, the shell 43 includes gearbox shell 431 and motor support 432 buckled to the gearbox shell 431. An accommodation space (not shown in the figure) is formed between the gearbox shell 431 and the motor support 432 to mount the drive device 42. Therefore, the drive device 42 becomes an independent module through the shell 43, facilitating the mounting and fixation of the drive device on the shell wall 14 of the base 1.

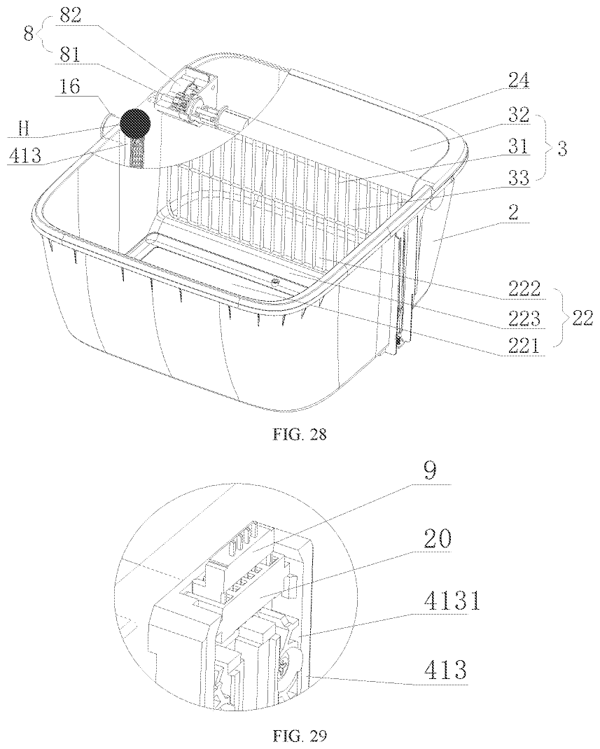

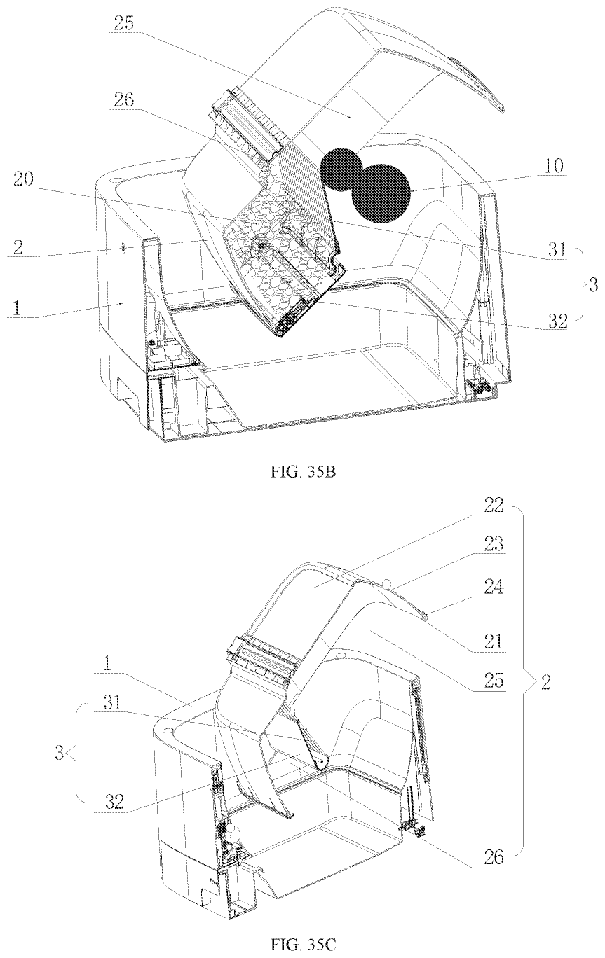

In addition, in some embodiments, as shown in FIG. 28, the filter screen plate 31 and the litter clean-up plate 32 can also be independently provided on the box body 2. The pet litter box further includes second drive mechanism 8. The second drive mechanism 8 is connected to the filter screen plate 31 and the litter clean-up plate 32 of the filter element 3. As shown in FIGS. 35A to 35D, the second drive mechanism 8 is configured to drive the filter screen plate 31 to rotate between a start position and a stop position of the box body 2. For example, when the box body 2 is rotated to the excrement dumping position, as shown in FIGS. 7A and 35B, the second drive mechanism 8 drives, according to a received drive instruction, the filter screen plate 31 to rotate towards the excretion region 25 of the box body 2. When the filter screen plate 31 is rotated to the stop position, the entire filter screen plate 31 is tilted towards the excretion region 25, forming a slope between the filter screen plate 31 and the box opening 21. Thus, the excrement or waste in the excretion region 25 can be easily dumped out of the box body 2 under the guidance of the slope of the filter screen plate 31. When the box body 2 is rotated to the excrement dumping position, as shown in FIG. 35C, the second drive mechanism 8 drives, according to a received drive instruction, the litter clean-up plate 32 to rotate towards the litter storage region 26, causing the litter clean-up plate 32 to open the litter storage region 26. When the box body 2 is rotated to the excrement dumping position, as shown in FIGS. 35B and 35C, as the excretion region 25 is located above the litter storage region 26, facilitating the dumping of the excrement or waste, and allowing the fine litter laid in the excretion region 25 to enter the litter storage region 26 through the filter hole 33 of the filter screen plate 31.

It is obvious from the above content that when the box body 2 is rotated to the excrement dumping position, the second drive mechanism 8 can drive the filter screen plate 31 to rotate towards the excretion region 25 according to a received instruction. When the filter screen plate 31 is rotated to the stop position, the entire filter screen plate 31 is tilted towards the excretion region 25, thereby forming a certain slope of the filter screen plate 31. The excrement or waste can be quickly slid down the slope of the filter screen plate 31, further facilitating the dumping of the excrement or waste. When the box body 2 is rotated to the excrement dumping position, if it is necessary to replace the fine litter in the box body 2, the second drive mechanism 8 continues to drive the litter clean-up plate 32 to rotate according to a received instruction, allowing the litter clean-up plate 32 to open the litter storage region 26 of the box body 2. When the excrement in the box body 2 is dumped, the fine litter in the litter storage region 26 can be dumped out. Therefore, during a litter replacement process, there is no need to disassemble the box body 2, which facilitates the user's litter replacement operation.

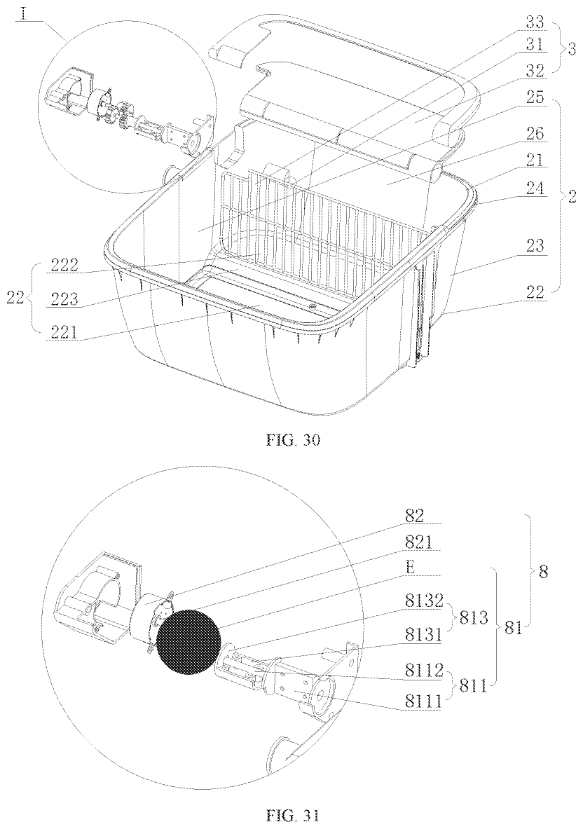

In addition, in some embodiments, when the box body 2 is rotated to the initial position, as shown in FIGS. 28 and 30, the second drive mechanism 8 drives the filter screen plate 31 to rotate towards the litter storage region 26 according to a received instruction. When the filter screen plate 31 is rotated to the start position, the entire filter screen plate 31 is tilted towards the litter storage region 26. In this way, an area of the excretion region 25 is effectively expanded, making it easy for the pet to enter the excretion region 25 and do its business in the excretion region 25.

Further, in some embodiments, when the box body 2 is at the initial position, before the second drive mechanism 8 drives the box body 2 to rotate to the excrement dumping position, the second drive mechanism 8 is further configured to drive the filter screen plate 31 to rotate towards the excretion region 25 according to a received instruction, as shown in FIGS. 28 and 30. As shown in FIG. 35A, the filter screen plate 31 can be rotated to a preset position between the start position and the stop position. As shown in FIG. 28, the filter screen plate 31 is perpendicular to the box opening 21 of the box body 2. It is obvious that before the box body 2 is rotated to the excrement dumping position, a gap between the filter screen plate 31 and the box bottom 22 can be reduced by rotating the filter screen plate 31 to the preset position perpendicular to the box opening 21. When the box body 2 is rotated to the excrement dumping position, the excrement or waste will not enter the litter storage region 26 through the gap between the filter screen plate 31 and the box bottom 22. Therefore, the box body 2 can dump the excrement or waste thoroughly, ensuring the cleanliness of the box body 2.

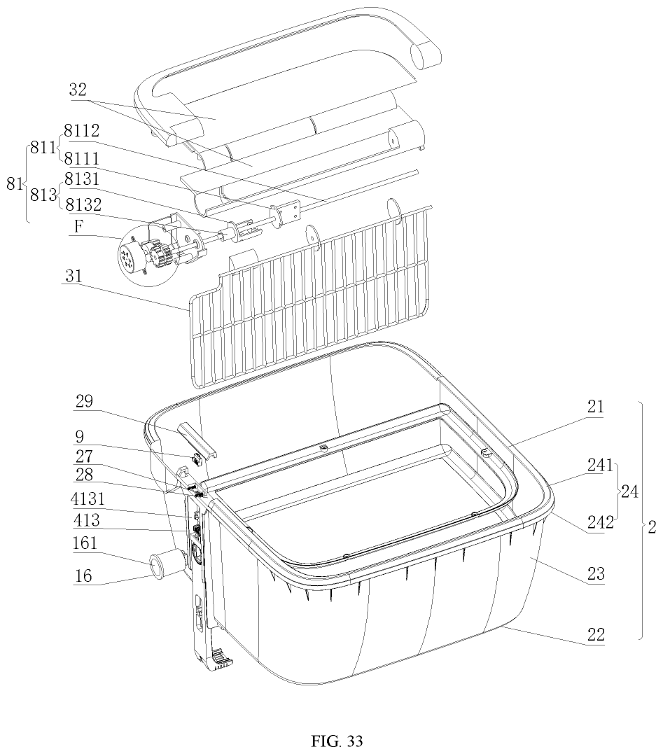

As shown in FIGS. 28 and 33, the second drive mechanism 8 includes transmission element 81 and drive element 82. The transmission element 81 and the drive element 82 are provided on the box body 2. The transmission element 81 is connected to the filter screen plate 31 and the litter clean-up plate 32, while the drive element 82 is connected to the transmission element 81. The drive element 82 is configured to drive the filter screen plate 31 to rotate within the box body 2 through the transmission element 81. The drive element 82 is further configured to drive the litter clean-up plate 32 to rotate through the transmission element 81.

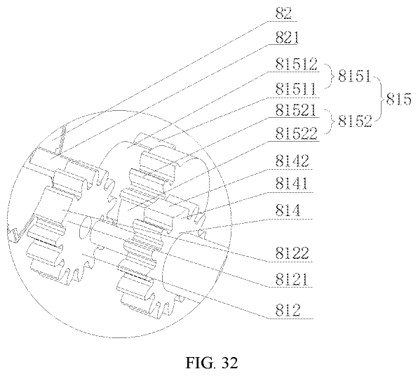

In some embodiments, as shown in FIGS. 28, 31, and 32, the drive element 82 is a motor drive element. The transmission element 81 includes first coupling 811, first driven gear 812, second coupling 813, second driven gear 814, and driving gear 815. As shown in FIG. 33, the first coupling 811 is connected to the filter screen plate 31. As shown in FIGS. 31 and 32, the first driven gear 812 is coaxially connected to the first coupling 811. As shown in FIG. 33, the second coupling 813 is connected to the litter clean-up plate 32. As shown in FIGS. 31 and 32, the second driven gear 814 is further coaxially connected to the second coupling 813. As shown in FIG. 32, the driving gear 815 is coaxially connected to the spindle 821 of the motor drive element. The driving gear 815 is further engaged with the first driven gear 812 and the second driven gear 814. Therefore, when the motor drive element drives the driving gear 815 to rotate through the spindle 821, the driving gear 815 can rely on the engagement with the first driven gear 812 and the second driven gear 814 to drive the first driven gear 812 and the second driven gear 814 to rotate, respectively. Finally, the first driven gear 812 drives the filter screen plate 31 to rotate through the first coupling 811, and the second driven gear 814 drives the litter clean-up plate 32 to rotate through the second coupling 813.

In some embodiments, as shown in FIGS. 31 and 33, the first coupling 811 includes first connecting element 8111 connected to the filter screen plate 31 and connecting shaft 8112 coaxially connected to the first driven gear 812 and the first connecting element 8111 separately. As shown in FIGS. 31 and 33, the second coupling 813 includes second connecting element 8131 connected to the litter clean-up plate 32 and connecting sleeve 8132 coaxially connected to the second driven gear 814 and the second connecting element 8131 separately. As shown in FIG. 32, the connecting sleeve 8132 and the second driven gear 814 are sleeved onto the connecting shaft 8112. The connecting sleeve 8132 and the second driven gear 814 are rotatable relative to the connecting shaft 8112. Therefore, when the connecting shaft 8112 is driven by the first driven gear 812, the filter screen plate 31 can be driven to rotate through the first connecting element 8111. When the filter screen plate 31 is rotated, the connecting sleeve 8132 and the second driven gear 814 are sleeved onto the connecting shaft 8112 and rotatable relative to the connecting shaft 8112. Therefore, the connecting sleeve 8132 and the second driven gear 814 will not follow the rotation of the first coupling 811, thereby avoiding interference with the rotation of the filter screen plate 31. On the contrary, when the litter clean-up plate 32 is rotated under the drive of the connecting sleeve 8132, the connecting sleeve 8132 and the second driven gear 814 still are sleeved onto the connecting shaft 8112 and rotatable relative to the connecting shaft 8112. Therefore, the first driven gear 812 will not follow the rotation of the second coupling 813, thereby avoiding interference with the rotation of the litter clean-up plate 32.

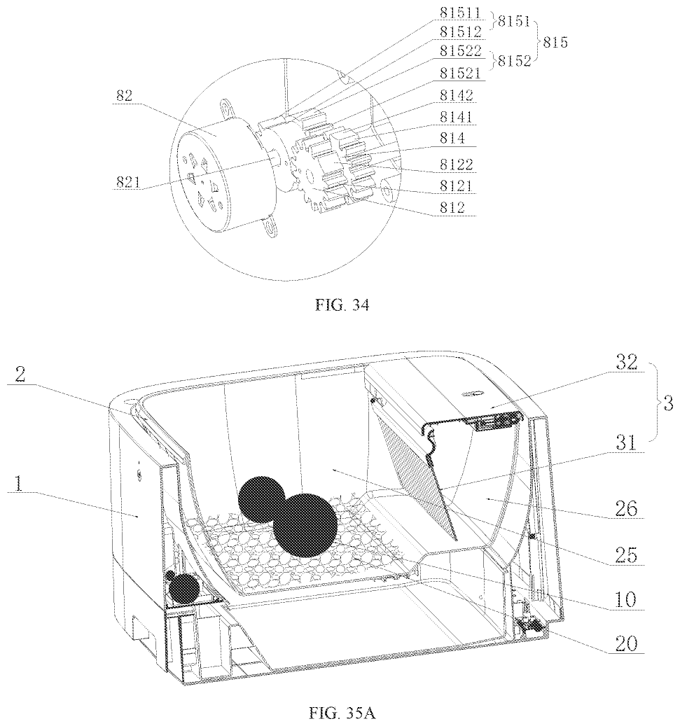

Furthermore, it is worth noting that in some embodiments, as shown in FIGS. 32 and 34, the driving gear 815 includes first gear ring 8151 and second gear ring 8152 coaxially fixed to the first gear ring 8151. The first gear ring 8151 and the second gear ring 8152 are coaxially connected to the spindle 821 of the motor drive element. The first gear ring 8151 includes first tooth portion 81511 engaged with the first driven gear 812 and first outwardly curved surface 81512 able to slip with the first driven gear 812. The second gear ring 8152 includes second tooth portion 81521 engaged with the second driven gear 814 and second outwardly curved surface 81522 able to slip with the second driven gear 814. As shown in FIG. 32, there is a preset angle difference between the first outwardly curved surface 81512 and the second outwardly curved surface 81522 around an axis of the spindle 821 of the motor drive element. Through this angle difference, when the filter screen plate 31 is rotated from the start position to the stop position, the first gear ring 8151 of the driving gear 815 is engaged with the first driven gear 812 through the first tooth portion 81511. The second gear ring 8152 of the driving gear 815 can slip with the second driven gear 814 through the second outwardly curved surface 81522. In this way, the litter clean-up plate 32 will not be rotated due to a driving force of the second coupling 813. On the contrary, when the filter screen plate 31 is moved to the stop position, as shown in FIG. 32, the first gear ring 8151 of the driving gear 815 can slip with the first driven gear 812 through the first outwardly curved surface 81512. The filter screen plate 31 can stay at the stop position, and the filter screen plate 31 will not be rotated due to a driving force of the first coupling 811. The second gear ring 8152 of the driving gear 815 can be engaged with the second driven gear 814 through the second tooth portion 81521. The litter clean-up plate 32 is rotated towards the litter storage region 26 due to a driving force of the connecting sleeve 8132, thereby opening the litter storage region 26 to dump out the fine litter in the litter storage region 26, achieving litter replacement.

In some embodiments, as shown in FIGS. 32 and 34, a top of at least one tooth 1121 of the first driven gear 812 is first inwardly curved surface 8122 that is able to slip with the first outwardly curved surface 81512 of the first gear ring 8151. Similarly, a top of at least one tooth 8141 of the second driven gear 814 is second inwardly curved surface 8142 that is able to slip with the second outwardly curved surface 81522. Therefore, when the filter screen plate 31 is rotated from the start position to the stop position, the second inner concave surface 8142 of the second driven gear 814 is fitted with the second outwardly curved surface 81522 of the second gear ring 8152, allowing the second driven gear 814 to slip with the driving gear 815. When the filter screen plate 31 is rotated to the stop position, the first inwardly curved surface 8122 of the first driven gear 812 is fitted with the first outwardly curved surface 81512 of the first gear ring 8151, allowing the first driven gear 812 to slip with the driving gear 815.

In addition, it is worth noting that the process of opening the litter storage region 26 by the litter clean-up plate 32 is only explained by taking the second drive mechanism 8 driving the litter clean-up plate 32 to rotate towards the litter storage region 26 as an example. In other embodiments, the litter storage region 26 can also be opened by enabling the second drive mechanism 8 to drive the litter clean-up plate 32 to rotate away from the litter storage region 26.

In addition, the second drive mechanism 8 further needs to be electrically connected to the main control module. When the main control module is electrically connected to the second drive mechanism 8, the electrical connection should avoid affecting the rotation of the box body 2. As shown in FIG. 33, the box body 2 is further provided with electrical connecting element 9. The electrical connecting element 9 is electrically connected to the second drive mechanism 8. As shown in FIG. 29, the electrical connecting element 9 is configured to connect electrical connector 20 on the rotation support 41 after the box body 2 is connected to the rotation support 41, such that the electrical connecting element 9 and the electrical connector 20 are electrically conductive. As shown in FIG. 33, a direction of the box body 2 from the box opening 21 to the box bottom 22 defines a height direction of the box body 2. The brim 24 is provided with mounting hole 27 along the height direction of the box body 2, and the electrical connecting element 9 is provided in the mounting hole 27 of the brim 24.

In some embodiments, as shown in FIG. 33, the brim 24 is provided with top side 241 and bottom side 242 opposite to the top side 241 in the height direction of the box body 2. The top side 241 of the brim 24 is further provided with mounting slot 28 communicated with the mounting hole 27 and upper cover 29 for sealing the mounting slot 28. The upper cover 29 is detachably connected to the brim 24. For example, the upper cover 29 is connected to the brim 24 in a clamping manner through a clamp or in a locking manner through a locking component such as a bolt. It is obvious that by sealing the mounting slot 28 with the upper cover 29, the electrical connecting element 9 provided in the mounting hole 27 is effectively protected. It should be noted that as shown in FIG. 29, the electrical connecting element 9 can be a male or female electrical connecting element. When the electrical connecting element 9 is a male electrical connecting element, the electrical connector 20 is a female electrical connector. When electrical connecting element 9 is a female electrical connecting element, the electrical connector 20 is a male electrical connector. In this way, when the box body 2 is connected to the rotation support 41, it facilitates the connection between the electrical connecting element 9 and the electrical connector 20, thereby achieving electrical continuity between the electrical connecting element 9 and the electrical connector 20.

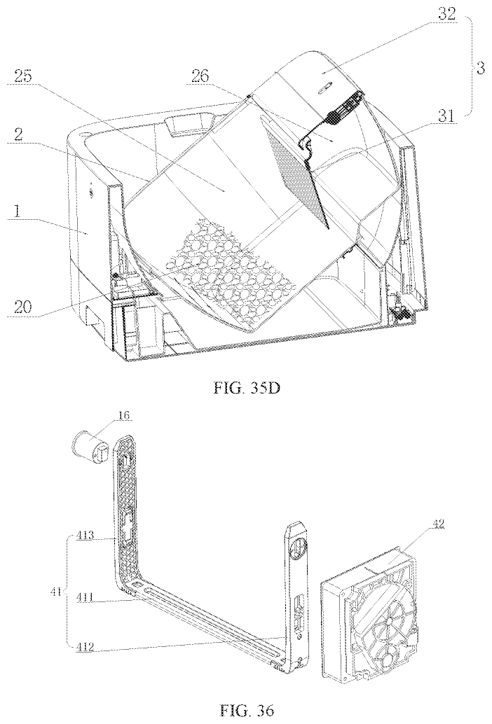

In addition, in some embodiments, as shown in FIG. 36, the first support beam 412 of the rotation support 41 serves as a driving rotating beam, and the second support beam 413 serves as a driven rotating beam. As shown in FIG. 33, the first support beam 412 is connected to the connecting portion 4211 of the drive device 42, and the second support beam 413 is provided with the electrical connector 20. For example, as shown in FIGS. 29 and 33, the electrical connector 20 is located at one end of the second support beam 413 away from the bottom beam 411. Of course, in some embodiments, the electrical connector 20 can further be located at other positions of the second support beam 413 or at other positions of the rotation support 41.

As shown in FIGS. 29 and 33, wiring channel 4131 is further provided inside the second support beam 413. The wiring channel 4131 is extended from one end of the second support beam 413 away from the bottom beam 62 to the other end thereof. The wiring channel 4131 is configured to guide a power supply harness connected to the electrical connector 20 to an outside of the second support beam 413, thereby facilitating the electrical connection between the main control module and the second drive mechanism 8.

In addition, in other embodiments, as shown in FIGS. 28 and 33, the shell wall 14 of the base 1 is rotatably provided with driven shaft 16, and the second support beam 413 is further connected to the driven shaft 16. As shown in FIG. 36, between the driven shaft 16 and the connecting portion 4211 of the drive device 42 are provided coaxially along the preset axis. The connecting portion 4211 and the driven shaft 16 are rotatable relative to the base 1 with the preset axis as a pivot axis. Therefore, when the box body 2 is connected to the first support beam 412 and the second support beam 413 of the rotation support 41, the rotation support 41 can be rotated under the drive of the connecting portion 4211, thereby driving the box body 2 to rotate within the chamber 11. It is worth noting that as shown in FIG. 33, the driven shaft 16 is provided with shaft hole 161 communicated with the wiring channel 4131 along the preset axis. Via the shaft hole 161, the power supply harness connected to the electrical connector 20 can be passed through the wiring channel 4131 to the outside of the second support beam 413. Therefore, when the rotation support 41 drives the box body 2 to rotate, with the help of the shaft hole 161, the power supply harness will not be twisted due to a driving force of the rotation support 41 during rotation. This ensures the stability of the second drive mechanism 8 driving the filter screen plate 31 and the litter clean-up plate 32 to rotate, and ensures the normal power supply and electrical signal transmission of the power supply harness to the second drive mechanism 8.

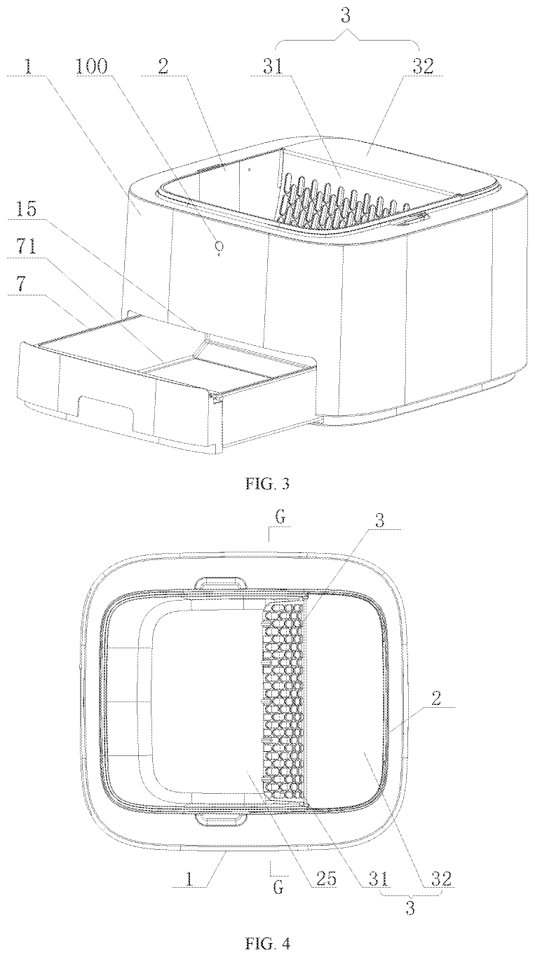

In addition, in some embodiments, as shown in FIGS. 1 and 3, the pet litter box further includes waste collector 7. The waste collector 7 is detachably provided in the chamber 11 and is located at the shell bottom 13 of the base 1. The waste collector 7 is configured to collect the excrement or waste dumped out of the box body 2 when the box body 2 is rotated to a first preset angle. The waste collector 7 facilitates the collection of the excrement or waste, and facilitates the clean-up of the excrement or waste by the user.

As shown in FIGS. 3 and 38, a side of the waste collector 7 facing the base opening 12 of the base 1 is provided with collection receptacle 71. The collection receptacle 71 facilitates the collection of the excrement or waste. In other embodiments, as shown in FIGS. 7A and 8A, when the box body 2 is rotated, a part of the box body invades the collection receptacle 71. Therefore, a second avoidance gap is formed between each receptacle wall 711 of the collection receptacle 71 and the box wall 23 of the box body 2 for the rotation of the box body 2. The second avoidance gap prevents the waste collector 7 from interfering with the rotation of the box body 2.

In addition, as shown in FIG. 3, the base 1 is further provided with outlet 15 communicated with the chamber 11. The outlet 15 is configured to slide the waste collector 7 into or out of the chamber 11. The outlet 15 is located on the first side plate 141, the second side plate 142, the third side plate 143, or the fourth side plate 144 of the shell wall 14. The user can remove and mount the waste collector 7 through the outlet 15, making it easy for the user to clean up the excrement or waste.

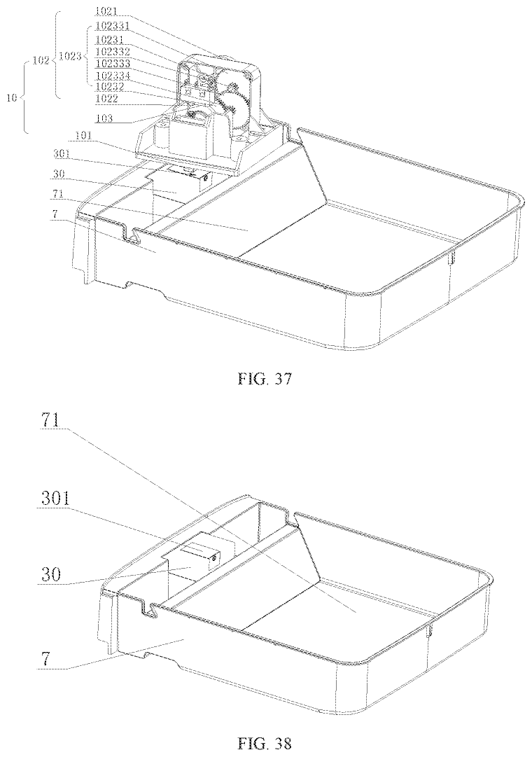

In addition, in some embodiments, the pet litter box further includes a deodorization device. As shown in FIGS. 37 and 38, the deodorization device includes liquid storage container 30 and pressing mechanism 10. The liquid storage container 30 is configured to store a deodorizing medium and is provided with press-type nozzle 301. The pressing mechanism 10 is configured to receive an electrical signal and press the nozzle 301 based on the received electrical signal, causing the nozzle 301 to extract the deodorizing medium from the liquid storage container 30 and spray the extracted deodorizing medium outward.

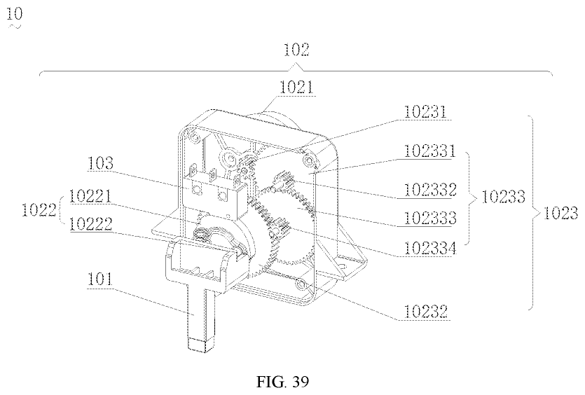

In some embodiments, as shown in FIGS. 37 and 39, the pressing mechanism 10 includes triggering element 101 and drive device 102. As shown in FIG. 37, the triggering element 101 is provided opposite to the nozzle 301. In some embodiments, the triggering element 101 may be a pressure lever. In addition, the drive device 102 can drive, according to the received electrical signal, the triggering element 101 to move relative to the nozzle 301, causing the triggering element 101 to press the nozzle 301.

In addition, as shown in FIG. 39, the drive device 102 includes motor 1021, crank element 1022 rotatably connected to the triggering element 101, and transmission element 1023 connected to a spindle of the motor 1021 and the crank element 1022. The motor 1021 is configured to drive the crank element 1022 to rotate through the transmission element 1023. The crank element 1022 can drive the triggering element 101 to move relative to the nozzle 301 during rotation, thereby enabling the nozzle 301 to extract and spray the deodorizing medium inside the liquid storage container 30.

In some embodiments, as shown in FIGS. 37, 39, and 40, the transmission element 1023 includes driving gear 10231, drive gear 10232, and gear set 10233. The driving gear 10231 is connected to the spindle of the motor 1021. The drive gear 10232 is eccentrically connected to the crank element 1022. The gear set 10233 is engaged with the driving gear 10231 and the drive gear 10232. The gear set 10233 includes first driven gear 102331 engaged with the driving gear 10231, second driven gear 102332 coaxially connected to the first driven gear 102331, third driven gear 102333 engaged with the second driven gear 102332, and fourth driven gear 102334 coaxially connected to the third driven gear. The fourth driven gear 102334 is further engaged with the drive gear 10232. It is obvious that through the engagement of the multi-stage driven gears, a driving force of the spindle of the motor is transmitted to the crank element 1022, causing the crank element 1022 to drive the triggering element 101 to move relative to the nozzle 301, so as to complete the extraction and spraying of the deodorizing medium. The sizes of the first driven gear 102331, the second driven gear 102332, the third driven gear 102333, and the fourth driven gear 102334 are adjustable based on an actual transmission ratio.

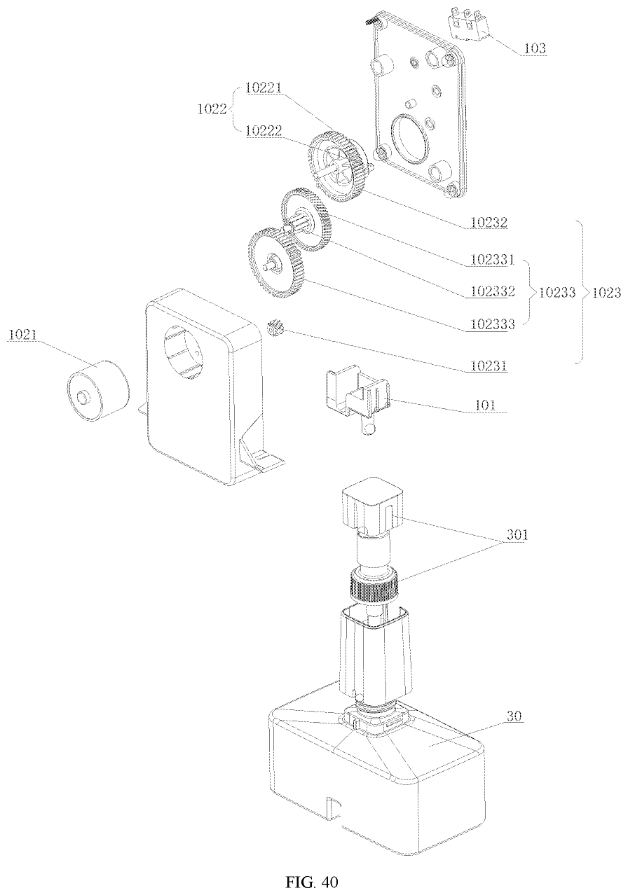

In addition, in some embodiments, as shown in FIGS. 39 and 40, the crank element 1022 includes eccentric wheel 10221 eccentrically connected to the drive gear 10232 and crank 10222 located on the eccentric wheel 10221. The crank 10222 can further be connected to the triggering element 101. When the drive gear 10232 is rotated, with the help of the eccentric connection between the eccentric wheel 10221 and the drive gear 10232, the crank 10222 can drive the triggering element 101 to move relative to the nozzle 301, thereby achieving the extraction and spraying of the deodorizing medium by the nozzle 301.

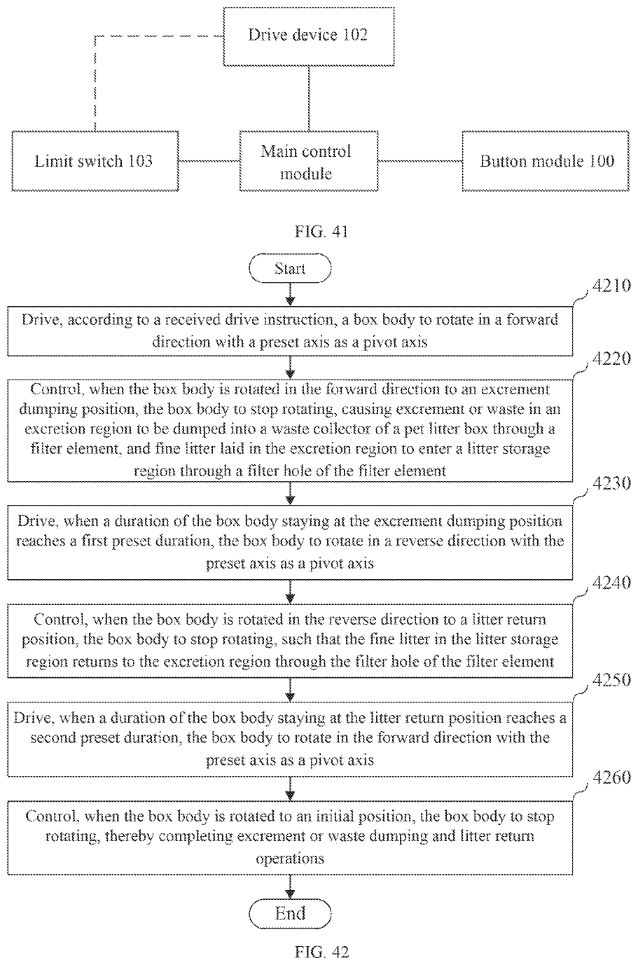

In addition, in some embodiments, as shown in FIGS. 37, 39, and 40, the pressing mechanism 10 includes limit switch 103. The limit switch 103 is provided with a triggering end abutted against the eccentric wheel 10221 of the crank element 1022. The triggering end is configured to trigger the limit switch 103 when the eccentric wheel 10221 is rotated to a preset angle, causing the limit switch 103 to output a detection signal. For example, as shown in FIG. 41, the limit switch 103 and the motor 1021 of the drive device 102 are electrically connected to the main control module. The main control module turns on the motor 1021 based on a received deodorization instruction, causing the drive device 102 to drive the triggering element 101 to move relative to the nozzle 301, thereby enabling the nozzle 301 to extract and spray the deodorizing medium. When the drive device 102 drives the triggering element 101, the eccentric wheel 10221 triggers the limit switch 103. Once the limit switch 103 is triggered, it outputs a detection signal to the main control module, causing the main control module to turn off the motor 1021. Of course, in some embodiments, a number of times the main control module receives the detection signal can further be set in advance. After the motor 1021 is turned on, the main control module will only turn off the motor 102 when the number of times it receives the detection signal output by the limit switch 103 reaches the preset number. Therefore, through the triggering element 101, multiple presses on the nozzle 301 can be achieved to achieve a desired deodorization effect.

In some embodiments, as shown in FIGS. 1, 2, and 3, the pet litter box further includes button module 100. The button module 100 is located on the base 1. As shown in FIG. 41, the button module 100 is further electrically connected to the main control module, and the button module 100 is configured to send the deodorization instructions to the main control module. The button module 100 can further serve as an executing component for sending a drive instruction to the main control module, enabling the main control module to turn on the first drive mechanism 4 and/or the second drive mechanism 8 based on the received drive instruction. For example, if the button module 100 is pressed once within a preset duration, the button module 100 sends a drive instruction to the main control module. If the button module 100 is pressed twice continuously within the preset duration, the button module 100 sends a deodorization instruction to the main control module. The main control module determines whether instruction sent by the button module 100 is a deodorization instruction or a drive instruction based on the number of times it receives the electrical signal output by the button module 100 within a preset time.

Some embodiments of the present disclosure further relate to a control method of a pet litter box. The control method is applied to the pet litter box as described above, and, as shown in FIG. 42, it includes the following steps.

According to the received drive instruction, the box body 2 of the pet litter box is driven to rotate with the preset axis as a pivot axis. The box opening 21 is configured to intersect with the base opening 12 of the base 1 when the box body 2 is rotated. The angle formed by the intersection of the box opening 21 and the base opening 12 changes with the rotation of the box body 2.

The process that according to the received drive instruction, the box body 2 is rotated to rotate with the preset axis as a pivot axis specifically includes the following steps.

Step 4210. According to the received drive instruction, the box body 2 is driven to rotate in the forward direction with the preset axis as a pivot axis.

Step 4220. When the box body 2 is rotated in the forward direction to the excrement dumping position, the box body 2 is controlled to stop rotating. The excrement or waste in the excretion region 25 is dumped into the waste collector 7 of the pet litter box through the filter element 3, and the fine litter laid in the excretion region 25 enters the litter storage region 26 through the filter hole 33 of the filter element 3. When the box body 2 is rotated to the excrement dumping position, the box opening 21 is tilted towards the base opening 12, and the excretion region 25 is located above the litter storage region 26.

Step 4230. When a duration of the box body 2 staying at the excrement dumping position reaches a first preset duration, the box body 2 is driven to rotate in the reverse direction with the preset axis as a pivot axis.

Step 4240. When the box body 2 is rotated in the reverse direction to the litter return position, the box body 2 is controlled to stop rotating, such that the fine litter in the litter storage region 26 returns to the excretion region 25 through the filter hole 33 of the filter element 3. When the box body 2 is rotated to the litter return position, as shown in FIGS. 5C and 35D, the box opening 21 is tilted towards the base opening 12, and the litter storage region 26 is located above the excretion region 25.

Step 4250. When a duration of the box body 2 staying at the litter return position reaches a second preset duration, the box body 2 is driven to rotate in the forward direction with the preset axis as a pivot axis.

Step 4260: When the box body 2 is rotated to the initial position, the box body 2 is controlled to stop rotating thereby completing excrement or waste dumping and litter return operations. When the box body 2 is rotated to the initial position, the box opening 21 is parallel to the base opening 12.

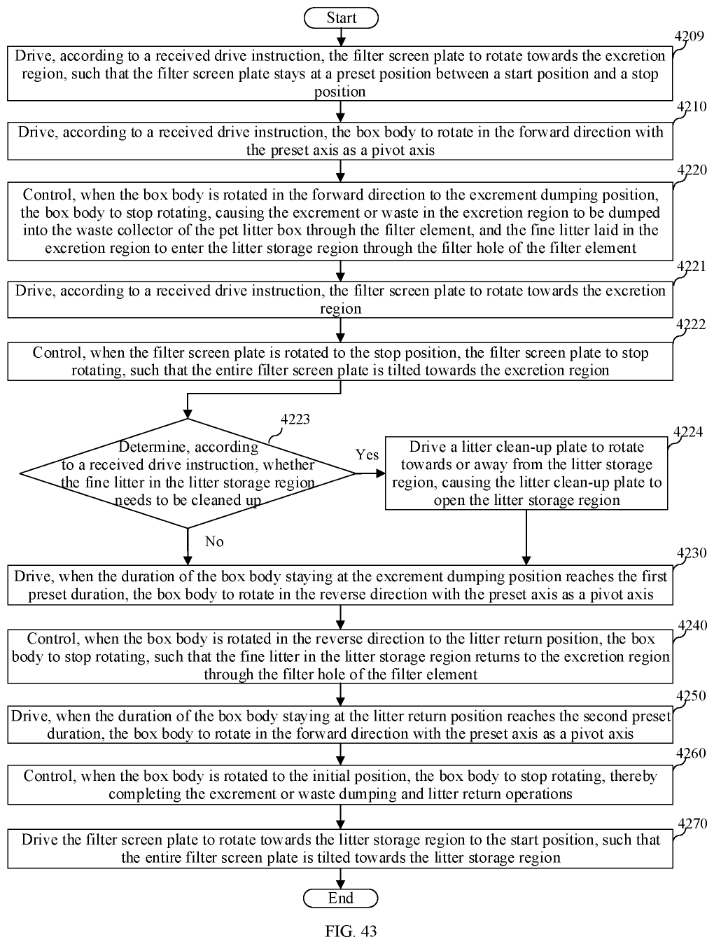

In addition, in some embodiments, as shown in FIGS. 4 and 5A, the filter screen plate 31 is extended from the box opening 21 to the box bottom 22, dividing the space inside the box body 2 into the excretion region 25 and the litter storage region 26. The litter clean-up plate 32 can cover a part of the box opening 21 to achieve the opening or closing of the litter storage region 26. Therefore, after step 4220 and before step 4230, as shown in FIG. 43, the control method further includes the following steps:

Step 4221. According to the received drive instruction, the filter screen plate 31 is driven to rotate towards the excretion region 25.

Step 4222. When the filter screen plate 31 is rotated to the stop position, the filter screen plate 31 is controlled to stop rotating, such that the entire filter screen plate 31 is tilted towards the excretion region 25. By rotating the filter screen plate 31, a slope is formed between the filter screen plate 31 and the box opening 21, thereby accelerating the dumping speed of the excrement or waste.

Step 4223. Based on the received drive instruction, it is determined whether the fine litter in the litter storage region 26 needs to be cleaned up. If the fine litter in the litter storage region does not need to be cleaned up, the operation proceeds to step 4230.

Step 4224: If the fine litter in the litter storage region needs to be cleaned up, the litter clean-up plate 32 is driven to rotate towards the litter storage region 26 or away from the litter storage region 26. As shown in FIG. 35C, the litter clean-up plate 32 opens the litter storage region 26. When a duration in which the litter clean-up plate 32 opens the litter storage region 26 reaches a third preset duration, step 4230 is continued. The third preset duration is less than the first preset duration.

In addition, step 4223 is specifically executed as follows.

If a duration of the received drive instruction is greater than or equal to a preset duration, the fine litter in the litter storage region needs to be cleaned up.

If the duration of the received drive instruction is less than the preset duration, the fine litter in the litter storage region does not need to be cleaned up.

For example, as shown in FIGS. 1 to 3, the button module 100 can be provided on the base 1. The button module 100 is configured to send the corresponding drive instruction to the main control module of the pet litter box. The main control module determines whether to clean up the fine litter in the litter storage region 26 based on the duration of the received drive instruction. For example, when the button module 100 is long pressed, the drive instruction sent to the main control module indicates that the fine litter in the litter storage region needs to be cleaned up. That is, when the box body 2 is rotated to the excrement dumping position, it is further necessary to perform a litter clean-up operation on the litter storage region 26 of the box body 2. When the button module 100 is short pressed, the drive instruction sent to the main control module indicates that the fine litter in the litter storage region does not need to be cleaned up. That is, when the box body 2 is rotated to the excrement dumping position, there is no need to perform a litter clean-up operation on the litter storage region 26 of the box body 2.

In addition, in some embodiments, after step 4260, as shown in FIG. 43, the control method further includes the following steps:

Step 4270. The filter screen plate 31 is driven to rotate towards the litter storage region 26 to the start position, such that the entire filter screen plate 31 is tilted towards the litter storage region 26. By rotating the filter screen plate 31 to the start position, the area of the excretion region 25 is effectively expanded, making it easy for the pet to enter and do its business in the excretion region 25.

In addition, in some embodiments, before step 4210, as shown in FIG. 43, the control method further includes the following steps:

Step 4209. According to the received drive instruction, the filter screen plate 31 is driven to rotate towards the excretion region 25, such that the filter screen plate 31 stays at the preset position between the start position and the stop position. When the filter screen plate 31 is rotated to the preset position, the filter screen plate 31 is perpendicular to the box opening 21 of the box body 2, effectively reducing the gap between the filter screen plate 31 and the box bottom 22 of the box body 2. When the box body 2 is rotated to the excrement dumping position, the excrement or waste will not enter the litter storage region 26 through the gap between the filter screen plate 31 and the box bottom 22. Therefore, when the excrement or waste in the box body 2 is dumped, the excrement or waste in the box body 2 can be dumped thoroughly, ensuring the cleanliness of the box body 2.

In addition, in some embodiments, the litter clean-up plate 32 can further be rotated independently on the box body 2, that is, the control method further includes the following steps:

According to the received drive instruction, it is determined whether the fine litter in the litter storage region 26 needs to be cleaned up. The determination method can be the determination method adopted in step 4223.

If the fine litter in the litter storage region needs to be cleaned up, the litter clean-up plate 32 is driven to rotate towards the litter storage region 26 or away from the litter storage region 26, causing the litter clean-up plate 32 to open the litter storage region 26.

Those of ordinary skill in the art should understand that the above embodiments are specific embodiments for implementing the present disclosure. In practical applications, various changes may be made to the above embodiments in terms of form and details without departing from the spirit and scope of the present disclosure.

1. A pet litter box, comprising:
a base, provided with a chamber, wherein a top side of the base is provided with a base opening communicated with the chamber; and
a box body, provided in the chamber, and provided with a box opening, wherein the box opening is located at a top side of the box body;
the box body comprises a box bottom opposite to the box opening and a box wall provided in a peripheral direction of the box bottom; and
the base comprises a shell bottom opposite to the base opening and a shell wall provided in a peripheral direction of the shell bottom; and the shell wall encloses the chamber on the shell bottom.

2. The pet litter box according to claim 1, wherein the box body is rotatable with a preset axis as a pivot axis; the box opening is configured to intersect with the base opening when the box body is rotated; and an angle formed by the intersection of the box opening and the base opening changes with the rotation of the box body.

3. The pet litter box according to claim 1, wherein the box body is provided therein with a filter element; the filter element divides a space inside the box body into an excretion region and a litter storage region, wherein the excretion region is allowed to contain fine litter and the litter storage region is communicated with the excretion region; the filter element is further provided with a filter hole, wherein the filter hole communicates the excretion region with the litter storage region; and a size of the filter hole is larger than a size of a fine litter particle and smaller than a size of an excrement particle.

4. The pet litter box according to claim 3, wherein the filter element is detachably provided in the box body, and comprises:
a filter screen plate, extended from the box opening to the box bottom, and dividing the space inside the box body into the excretion region and the litter storage region; and
the filter screen plate is curved towards the excretion region or the litter storage region, making the filter screen plate formed into a curved plate.

5. The pet litter box according to claim 3, wherein the box body is further provided with a litter clean-up plate; and the litter clean-up plate covers a part of the box opening, and is configured to open or close the litter storage region.

6. The pet litter box according to claim 4, wherein the box bottom is provided with a first bottom portion, a second bottom portion, and a connecting portion connecting the first bottom portion and the second bottom portion; a vertical distance from the box opening to the first bottom portion is greater than a vertical distance from the box opening to the second bottom portion; and the connecting portion is tilted, from an end connected to the first bottom portion to an end connected to the second bottom portion, towards the litter storage region; and
the filter screen plate is butted against a side of the connecting portion connected to the first bottom portion.

7. The pet litter box according to claim 4, wherein the filter screen plate comprises:
a frame, extended from the box opening to the box bottom; and
a screen plate body, provided within the frame, wherein a part of the screen plate body forms a flip plate flippable towards the excretion region and a litter return port opened or closed by the flip plate.

8. The pet litter box according to claim 7, wherein a side of the flip plate hinged to the frame is parallel to the box opening; and the flip plate is configured to flip relative to the frame when the box body is rotated; and
the flip plate is further configured to close the litter return port when the box body is rotated to a first preset position and open the litter return port when the box body is rotated to a second preset position.

9. The pet litter box according to claim 3, further comprising:
a first drive mechanism, connected to the box body, and configured to drive the box body to rotate with a preset axis as a pivot axis;
wherein, when the first drive mechanism drives the box body to rotate to an excrement dumping position, the box opening is tilted towards the base opening; and the excretion region is located above the litter storage region;
when the first drive mechanism drives the box body to rotate to a litter return position, the box opening is tilted towards the base opening; and the excretion region is located below the litter storage region; and
when the first drive mechanism drives the box body to rotate to an initial position, the box opening is parallel to the base opening.

10. The pet litter box according to claim 9, wherein the first drive mechanism comprises:
a rotation support, provided in the chamber, and connected to the box body; and
a drive device, connected to the rotation support, and configured to drive the rotation support to rotate with the preset axis as the pivot axis.

11. The pet litter box according to claim 10, wherein the rotation support comprises:
a bottom beam;
a first support beam, provided at a first end of the bottom beam in a length direction of the bottom beam, and extended in a direction perpendicular to the bottom beam; and
a second support beam, provided at a second end of the bottom beam in the length direction of the bottom beam, and extended in the direction perpendicular to the bottom beam;
wherein, the first support beam, the second support beam, and the bottom beam define a clamping region for clamping the box body; and an end of the first support beam away from the bottom beam and an end of the second support beam away from the bottom beam are rotatably connected to the base.

12. The pet litter box according to claim 11, wherein the first support beam and the second support beam are detachably connected to the box body.

13. The pet litter box according to claim 3, wherein the box body is provided with a filter screen plate and a litter clean-up plate; the filter screen plate is extended from the box opening to the box bottom, and divides the space inside the box body into the excretion region and the litter storage region; and the litter clean-up plate covers a part of the box opening, and is configured to open or close the litter storage region;
the pet litter box further comprises: a second drive mechanism, connected to the filter screen plate and the litter clean-up plate, and configured to drive the filter screen plate to rotate between a start position and a stop position in the box body;
when the box body is rotated to an excrement dumping position, the second drive mechanism is further configured to drive, according to a received drive instruction, the filter screen plate to rotate towards the excretion region; and when the filter screen plate is rotated to the stop position, the filter screen plate is tilted towards the excretion region;
when the box body is rotated to the excrement dumping position, the second drive mechanism is further configured to drive, according to a received drive instruction, the litter clean-up plate to rotate towards or away from the litter storage region, causing the litter clean-up plate to open or close the litter storage region; and
when the box body is rotated to the excrement dumping position, the box opening is tilted towards the base opening; and the excretion region is located above the litter storage region.

14. The pet litter box according to claim 13, wherein when the box body is rotated to an initial position, the second drive mechanism is further configured to drive, according to a received drive instruction, the filter screen plate to rotate towards the litter storage region; and when the filter screen plate is rotated to the start position, the filter screen plate is tilted towards the litter storage region; and
before the box body is rotated to the excrement dumping position when the box body is at the initial position, the second drive mechanism is further configured to drive, according to a received instruction, the filter screen plate to rotate towards the excretion region to a preset position between the start position and the stop position, wherein the filter screen plate is perpendicular to the box opening.

15. The pet litter box according to claim 13, wherein the second drive mechanism comprises:
a transmission element, provided on the box body, and connected to the filter screen plate and the litter clean-up plate; and
a drive element, provided on the box body, connected to the transmission element, and configured to drive the filter screen plate to rotate within the box body through the transmission element and drive the litter clean-up plate to rotate through the transmission element.

16. The pet litter box according to claim 2, further comprising:
a waste collector, detachably provided in the chamber, and located at the shell bottom;
wherein, the waste collector is configured to collect excrement or waste dumped out of the box body when the box body is rotated to the excrement dumping position; and
the base is provided with an outlet communicated with the chamber; and the outlet is configured to slide the waste collector into or out of the chamber.

17. The pet litter box according to claim 16, wherein a side of the waste collector facing the base opening is provided with a collection receptacle; the collection receptacle is configured to collect the excrement or waste; and a part of the box body invades the collection receptacle.

18. The pet litter box according to claim 16, further comprising: a deodorization device, comprising:
a liquid storage container, provided on the waste collector, configured to store a deodorizing medium, and provided with a press-type nozzle; and
a pressing mechanism, configured to receive an electrical signal and press the press-type nozzle based on the received electrical signal, causing the press-type nozzle to extract the deodorizing medium from the liquid storage container and spray the extracted deodorizing medium outward.

19. The pet litter box according to claim 18, wherein the pressing mechanism comprises:
a triggering element, provided opposite to the press-type nozzle of the liquid storage container; and
a drive device, configured to receive an electrical signal and drive, according to the received electrical signal, the triggering element to move relative to the press-type nozzle, causing the triggering element to press the press-type nozzle.

20. A control method of a pet litter box, wherein the control method is applied to the pet litter box according to claim 1 and comprises the following steps:
driving, according to a received drive instruction, the box body to rotate with a preset axis as a pivot axis;
wherein, the box opening is configured to intersect with the base opening of the base when the box body is rotated; and an angle formed by the intersection of the box opening and the base opening changes with the rotation of the box body.

21. The control method according to claim 20, wherein the box body is provided therein with a filter element; the filter element divides a space inside the box body into an excretion region and a litter storage region, wherein the excretion region is allowed to contain fine litter and the litter storage region is communicated with the excretion region; the filter element is further provided with a filter hole, wherein the filter hole communicates the excretion region with the litter storage region; and a size of the filter hole is larger than a size of a fine litter particle and smaller than a size of an excrement particle;
the step of driving, according to the received drive instruction, the box body to rotate with the preset axis as the pivot axis comprises:
driving, according to the received drive instruction, the box body to rotate in a forward direction with the preset axis as the pivot axis;
controlling, when the box body is rotated in the forward direction to an excrement dumping position, the box body to stop rotating, causing excrement or waste in the excretion region to be dumped into a waste collector of the pet litter box through the filter element, and the fine litter laid in the excretion region to enter the litter storage region through the filter hole of the filter element, wherein when the box body is rotated in the forward direction to the excrement dumping position, the box opening is tilted towards the base opening; and the excretion region is located above the litter storage region;
driving, when a duration of the box body staying at the excrement dumping position reaches a first preset duration, the box body to rotate in a reverse direction with the preset axis as the pivot axis;
controlling, when the box body is rotated in the reverse direction to a litter return position, the box body to stop rotating, wherein the fine litter in the litter storage region returns to the excretion region through the filter hole of the filter element, wherein when the box body is rotated in the reverse direction to the litter return position, the box opening is tilted towards the base opening, and the litter storage region is located above the excretion region;
driving, when a duration of the box body staying at the litter return position reaches a second preset duration, the box body to rotate in the forward direction with the preset axis as the pivot axis; and
controlling, when the box body is rotated to an initial position, the box body to stop rotating, wherein excrement or waste dumping and litter return operations are completed, wherein when the box body is rotated to the initial position, the box opening is parallel to the base opening.

22. The control method according to claim 21, wherein the filter element comprises a filter screen plate and a litter clean-up plate; the filter screen plate divides the space inside the box body into the excretion region and the litter storage region; and the litter clean-up plate covers a part of the box opening, and is configured to open or close the litter storage region;
the control method further comprises the following steps before driving the box body to rotate in the reverse direction with the preset axis as the pivot axis after the box body is rotated in the forward direction to the excrement dumping position:
driving, according to a received drive instruction, the filter screen plate to rotate towards the excretion region;
controlling, when the filter screen plate is rotated to a stop position, the filter screen plate to stop rotating, wherein the filter screen plate is tilted towards the excretion region;
determining, according to a received drive instruction, whether the fine litter in the litter storage region needs to be cleaned up; and
if the fine litter in the litter storage region needs to be cleaned up, driving the litter clean-up plate to rotate towards or away from the litter storage region, causing the litter clean-up plate to open the litter storage region.

23. The control method according to claim 22, further comprising the following step when the box body is rotated to the initial position:
driving the filter screen plate to rotate towards the litter storage region to a start position, wherein the filter screen plate is tilted towards the litter storage region.

24. The control method of a pet litter box according to claim 23, further comprising the following step before driving the box body to rotate in the forward direction with the preset axis as the pivot axis after the drive instruction is received:
driving, according to the received drive instruction, the filter screen plate to rotate towards the excretion region, wherein the filter screen plate stays at a preset position between the start position and the stop position, wherein when the filter screen plate is rotated to the preset position, the filter screen plate is perpendicular to the box opening.

25. The control method according to claim 20, wherein the box body is provided therein with a filter screen plate and a litter clean-up plate; the filter screen plate divides the space inside the box body into the excretion region and the litter storage region; the litter clean-up plate covers a part of the box opening, and is configured to open or close the litter storage region; and the control method further comprises:
determining, according to a received drive instruction, whether the fine litter in the litter storage region needs to be cleaned up; and
if the fine litter in the litter storage region needs to be cleaned up, driving the litter clean-up plate to rotate towards or away from the litter storage region, causing the litter clean-up plate to open the litter storage region.
